(19) United States
(12) Patent Application Publication
(10) Pub. No.: US 2015/0325200 A1
(43) Pub. Date: Nov. 12, 2015

(54) SOURCE DRIVER AND DISPLAY DEVICE INCLUDING THE SAME

(71) Applicant: SAMSUNG ELECTRONICS CO., LTD., Suwon-si (KR)

(72) Inventors: Ho-hak RHO, Yongin-si (KR); Gyu-sung PARK, Yongin-si (KR); Seung-jung LEE, Hwaseong-si (KR); Jun-kwan PARK, Seoul (KR)

(73) Assignee: SAMSUNG ELECTRONICS CO., LTD., Suwon-si (KR)

(21) Appl. No.: 14/706,134

(22) Filed: May 7, 2015

(30) Foreign Application Priority Data
May 7, 2014 (KR) 10-2014-0054437

(51) Int. Cl. G09G 5/00

(52) U.S. Cl. CPC G09G 5/00; G09G 2330/021; G09G 2360/08

(57) ABSTRACT

Provided are a source driver configured to drive a display panel and a display device including the same. A source driver configured to drive a source line of a display panel includes a digital circuit configured to receive and store digital pixel data, and an analog circuit configured to convert the stored digital pixel data into an analog-signal-type gradation voltage and output the analog-signal-type gradation voltage. A static current of the analog circuit is reduced in response to a value of a timing signal corresponding to a non-driving section of the display panel.

### CROSS-REFERENCE TO RELATED APPLICATION

This application claims priority from Korean Patent Application No. 10-2014-0054437, filed on May 7, 2014, in the Korean Intellectual Property Office, the disclosure of which is incorporated herein by reference in its entirety.

### BACKGROUND

Exemplary embodiments relate to a display device. In particular, exemplary embodiments relate to a source driver configured to drive a display panel and a display device including the source driver.

A display device used in electronic products, such as laptop computers, computers, TVs, and cell phones, may include a display panel configured to embody images and a driver circuit configured to drive the display panel. The display panel may include gate lines arranged in a row direction, source lines arranged in a column direction, and a plurality of pixels arranged at a matrix at intersections between the gate lines and the source lines. The driver circuit may include a gate driver configured to provide scan signals in the row direction and a source driver configured to provide image signals of the respective pixels in the column direction. As the size and resolution of the display panel increase, power consumption of the driver circuit increases. An increase in the power consumption of the driver circuit may lead to an increase in the amount of heat radiated. Therefore, the size of a battery of a display system needs to increase. Accordingly, a driver circuit capable of operating at a low power is required.

### SUMMARY

Exemplary embodiments may provide a source driver capable of reducing power consumption and a display device including the source driver.

According to an aspect of the exemplary embodiments, there is provided a source driver configured to drive a source line of a display panel. The source driver includes a digital circuit configured to receive and store digital pixel data, and an analog circuit configured to convert the stored digital pixel data into an analog-signal-type gradation voltage and output the gradation voltage. A static current of the analog circuit is reduced in response to a value of a timing signal corresponding to a non-driving section of the display panel.

The analog circuit may include at least one amplifier configured to buffer an analog signal. An operation of an output buffer included in the at least one amplifier may be cut off in response to the value of the timing signal corresponding to the non-driving section.

A bias current of the at least one amplifier may be reduced or cut off in response to the value of the timing signal corresponding to the non-driving section.

The analog circuit may include a gamma block configured to generate a plurality of gradation voltages, and an output buffer configured to buffer and output a selected gradation voltage which corresponds to the pixel data, among the gradation voltages.

The output buffer may include a plurality of output amplifier, each output amplifier of the output amplifiers include an input stage and an output stage, and a bias circuit configured to generate a bias signal which controls a plurality of biases of the plurality of output amplifier. The bias circuit may reduce a bias current of each of the output amplifiers in response to the value of the timing signal corresponding to the non-driving section of the display panel, and cut off an operation of the output stage of at least one output amplifier in response to the value of the timing signal corresponding to the non-driving section of the display panel.

The bias circuit may output the bias signal for cutting off the bias current of each of the plurality of output amplifiers in response to the value of the timing signal corresponding to the non-driving section of the display panel.

The gamma block may include a plurality of gamma amplifiers configured to buffer a plurality of received gamma reference voltages, a bias circuit configured to generate a bias signal which controls a plurality of biases of the plurality of gamma amplifiers, and a voltage divider configured to voltage divide the buffered gamma reference voltages. Operations of an output stage of at least one gamma amplifier of the plurality of gamma amplifiers may be blocked in response to the value of the timing signal corresponding to the non-driving section.

In response to the value of the timing signal corresponding to the non-driving section, one of the gamma reference voltages and power supply voltages may be applied to one terminal of the voltage divider.

In response to the value of the timing signal corresponding to the non-driving section, at least one gamma amplifier of the plurality of gamma amplifiers may operate, and one terminal of the voltage divider may be connected to an output of the at least one gamma amplifier.

In response to the value of the timing signal corresponding to the non-driving section, a plurality of bias currents of the plurality of gamma amplifiers may be cut off, and operations of a plurality of output stages of the plurality of gamma amplifiers may be blocked.

The output buffer may include a plurality of output amplifiers, each output amplifier of the output amplifiers includes an input stage configured to operate with an application of a first power supply voltage and a second power supply voltage, a first output stage configured to operate with an application of the first power supply voltage and a third power supply voltage, and a second output stage configured to operate with an application of the third power supply voltage and the second power supply voltage, and one output stage of the first output stage and the second output stage of each of the plurality of output amplifiers selectively operates based on a polarity control signal.

The source driver may further include a switch configured to transmit the third power supply voltage to the source line of the display panel in a polarity inversion section instead of transmitting an output voltage of the output amplifier to the source line of the display panel.

The non-driving section may be a vertical blank section.

According to another aspect of the exemplary embodiments, there is provided a source driver including: a gamma block which includes a plurality of gamma amplifiers and is configured to generate a plurality of gradation voltages, and an output buffer configured to buffer and output a gradation voltage which corresponds to pixel data, among the plurality of gradation voltages. An input stage and an output stage of at least one gamma amplifier of the plurality of gamma amplifiers may have different operating voltage ranges.

The input stage of the at least one gamma amplifier may have a wider operating voltage range than the output stage of the at least one gamma amplifier.

Some of the plurality of gamma amplifiers may generate output voltages based on a first power supply voltage and a third power supply voltage, and some others of the plurality of gamma amplifiers may generate output voltages based on a second power supply voltage and the third power supply voltage.

A sink current of the some of the gamma amplifiers may be reused as a source current of the some others of the gamma amplifiers.

The sink current may be a same amount as the source current.

The some of the gamma amplifiers may have symmetrical configurations with respect to the some others of the gamma amplifiers.

The third power supply voltage may be a middle voltage which is between the first power supply voltage and the second power supply voltage.

According to another aspect of the exemplary embodiments, there is provided a source driver including: a digital circuit which is configured to receive pixel data and a control signal and output the pixel data, and an analog circuit which is configured to receive the output pixel data and a vertical blank signal and output a gradation voltage. A static current of the analog circuit is reduced in response to a predefined value of the vertical blank signal.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a source driver according to various exemplary embodiments of the inventive concept;

FIG. 2 is a timing diagram of an example of a signal waveform of the source driver of FIG. 1;

FIG. 3 shows a data packet of FIG. 2;

FIG. 4 is a schematic block diagram of an output buffer unit of FIG. 1;

FIG. 5 is a schematic circuit diagram of an output amplifier of FIG. 4;

FIG. 6A is a diagram of an example in which the output buffer circuit of FIG. 4 controls a bias current of an output amplifier;

FIG. 6B is a timing diagram of signals of FIG. 6A;

FIG. 7A is a diagram of another example in which the output buffer unit of FIG. 4 controls a bias current of an output amplifier;

FIG. 7B is a timing diagram of signals of FIG. 7A;

FIG. 8 is a block diagram of an example of a gamma block of FIG. 1;

FIG. 9 is a block diagram of another example of the gamma block of FIG. 1;

FIG. 10 is a block diagram of another example of the gamma block of FIG. 1;

FIG. 11 is a block diagram of a source driver according to another exemplary embodiment of the inventive concept;

FIG. 12 is a diagram for explaining a column inversion operation;

FIG. 13 is a graph of a gradation voltage relative to a gray level of pixel data;

FIG. 14 is a schematic block diagram of a gamma block of FIG. 11;

FIG. 15 is a diagram of power supply voltages applied to a high gamma amplifier and a low gamma amplifier of FIG. 14;

FIG. 16 is a diagram for explaining reuse of current in a gamma block of FIG. 11;

FIG. 17 is a schematic block diagram of an output buffer unit of FIG. 11;

FIGS. 18A and 18B are diagrams for explaining operations of the output buffer unit of FIG. 17 in response to a polarity control signal;

FIG. 19 is a timing diagram of the output buffer unit of FIG. 17;

FIGS. 20A and 20B are block diagrams of display devices to which source drivers according to exemplary embodiments of the inventive concept are applied;

FIG. 21 is a diagram of a display module according to exemplary embodiments of the inventive concept;

FIG. 22 is a diagram of a display system according to exemplary embodiments of the inventive concept; and

FIG. 23 is a diagram of various applied examples of an electronic product on which a display device according to exemplary embodiments of the inventive concept is mounted.

### DETAILED DESCRIPTION OF THE EXEMPLARY EMBODIMENTS

The present inventive concept will now be described more fully hereinafter with reference to the accompanying drawings, in which exemplary embodiments of the inventive concept are shown. These exemplary embodiments are provided so that this disclosure is thorough and complete and fully conveys the scope of the inventive concept to one skilled in the art. Accordingly, while the inventive concept can be modified in various ways and take on various alternative forms, specific exemplary embodiments thereof are shown in the drawings and described in detail below as examples. There is no intent to limit the inventive concept to the particular forms disclosed. On the contrary, the inventive concept is to cover all modifications, equivalents, and alternatives falling within the spirit and scope of the appended claims. Like reference numerals refer to like elements throughout. In the drawings, the thicknesses of layers and regions may be exaggerated for clarity.

The terminology used herein is for the purpose of describing particular exemplary embodiments only and is not intended to be limiting of the example embodiments. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

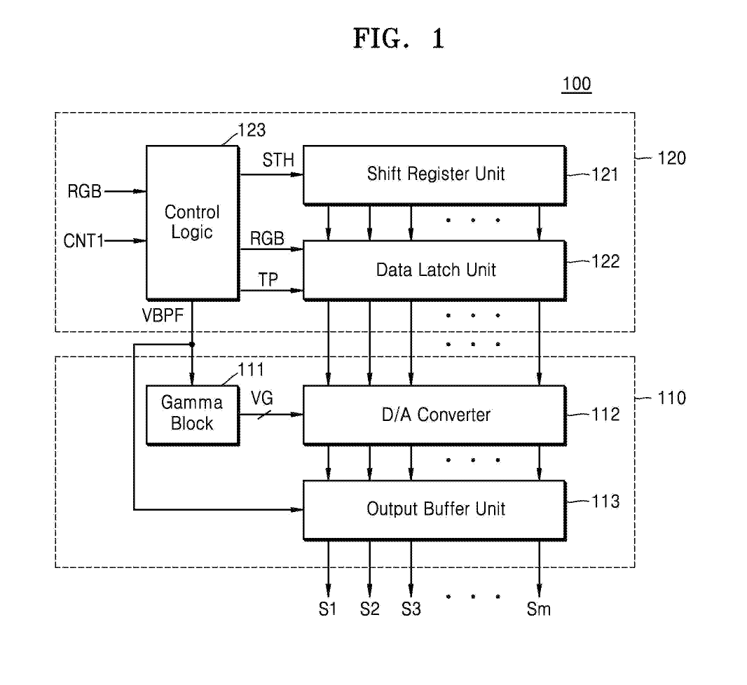

FIG. 1 is a block diagram of a source driver 100 according to exemplary embodiments of the inventive concept.

Referring to FIG. 1, the source driver 100 may include a digital circuit 120 and an analog circuit 110. The digital circuit 120 may receive and store digital-signal-type pixel data RGB. The analog circuit 110 may convert the pixel data RGB into an analog-signal-type gradation voltage and output the gradation voltage to source lines S1 to Sm of a display panel.

The digital circuit 120 may include a shift register unit 121 and a data latch unit 122. Also, the digital circuit 120 may further include a control logic 123.

The shift register unit 121 may control time points at which the pixel data RGB is sequentially stored in the data latch unit 122. The shift register unit 121 may sequentially shift a vertical synchronous start signal STH and provide shifted clock signals to the data latch unit 122.

The data latch unit 122 may include a plurality of latch circuits and sequentially store pixel data RGB corresponding to one horizontal line from a latch circuit on one end of the data latch unit 122 to a latch circuit on the other end thereof. When the storing of the pixel data RGB is finished, the data latch unit 122 may output pixel data RGB in response to a load signal TP.

The control logic 123 may receive the pixel data RGB and a source driver control signal CNT1 and generate internal control signals, namely, the vertical synchronous start signal STH, the load signal TP, and a vertical blank signal VBPF, based on the source driver control signal CNT1. The source driver control signal CNT1 may include a clock signal, a polarity control signal POL, or information signals regarding driving time points. The source driver control signal CNT1 may be received as a data packet type along with the pixel data RGB. The control logic 123 may parallelize serialized and received pixel data RGB and transmit the parallelized pixel data RBG to the data latch unit 122.

FIG. 1 illustrates an example in which the digital circuit 120 includes the control logic 123, but the inventive concept is not limited thereto. The digital circuit 120 may not include the control logic 123, but control signals, namely, the vertical synchronous start signal STH, the load signal TP, and the vertical blank signal VBPF, may be externally and directly provided to the digital circuit 120. For example, when the source driver 100 is integrated in a single semiconductor chip along with a timing controller configured to provide the pixel data RGB and the source driver control signal CNT1, the control signals, namely, the vertical synchronous start signal STH, the load signal TP, and the vertical blank signal VBPF, may be provided from the timing controller.

The analog circuit 110 may include a gamma block 111, a digital-to-analog converter (DAC) 112, and an output buffer unit 113.

The gamma block 111 may generate gradation voltages VG corresponding to respective gray levels indicated by pixel data RGB. For example, when the pixel data RGB is an N-bit data signal, the gamma block 111 may generate 2N gradation voltages VG. Furthermore, when a display panel driven by the source driver 100 is a liquid crystal display (LCD) panel, the gamma block 111 may generate 2N high gradation voltages having a higher voltage level than a common voltage applied in common to LCs of pixels and 2N low gradation voltages having a lower voltage level than the common voltage.

The DAC 112 may receive the pixel data RGB output by the data latch unit 122 and output an analog gradation voltage corresponding to the pixel data RGB out of the gradation voltages VG. For example, a gamma decoder, which is a kind of DAC 112, may decode N-bit pixel data RGB, select one out of 2N gradation voltages in response to a decoding result, and output the selected gradation voltage. Furthermore, the DAC 112 may select one gradation voltage out of 2N high gradation voltages and 2N low gradation voltages based on a polarity control signal and output the selected gradation voltage.

The output buffer unit 113 may buffer and output the analog gradation voltage output by the DAC 112.

The source driver 100 according to the exemplary embodiment of the inventive concept may operate the analog circuit 110 in a power-down mode in a non-driving section of the display panel. For example, the non-driving section may be a vertical blank section. The vertical blank section may be a section between image frames displayed on the display panel, namely, a section after a gradation voltage corresponding to a final horizontal line of one image frame is output and before a gradation voltage corresponding to a first horizontal line of the next image frame is output. In the vertical blank section, the gradation voltage may not be applied to the pixels of the display panel.

Accordingly, the source driver 100 according to the exemplary embodiment of the inventive concept may operate the analog circuit 110 in the power-down mode, based on the vertical blank signal VBPF in the vertical blank section, and reduce power consumption.

The control logic 123 may generate a vertical blank signal VBPF indicating the vertical blank section, based on an externally received source driver control signal CNT1, and provide the vertical blank signal VBPF to the analog circuit 110. For example, the control logic 123 may generate the vertical blank signal VBPF based on a signal indicating a final line of an image frame and a signal indicating a first line of the next image frame, out of signals included in the source driver control signal CNT1. However, the inventive concept is not limited to the above-described example. The vertical blank signal VBPF may be generated in various manners in the source driver 100 or externally and directly provided.

The gamma block 111 and the output buffer unit 113 of the analog circuit 110 may control a static current based on the vertical blank signal VBPF. When the vertical blank signal VBPF is activated (for example, to a logic high), an operation of an output stage of an amplifier included in at least one of the gamma block 111 and the output buffer unit 113 may be cut off, or a bias current of the amplifier may be reduced. Thus, a static current of the analog circuit 110 may be reduced. Detailed descriptions thereof will be presented below.

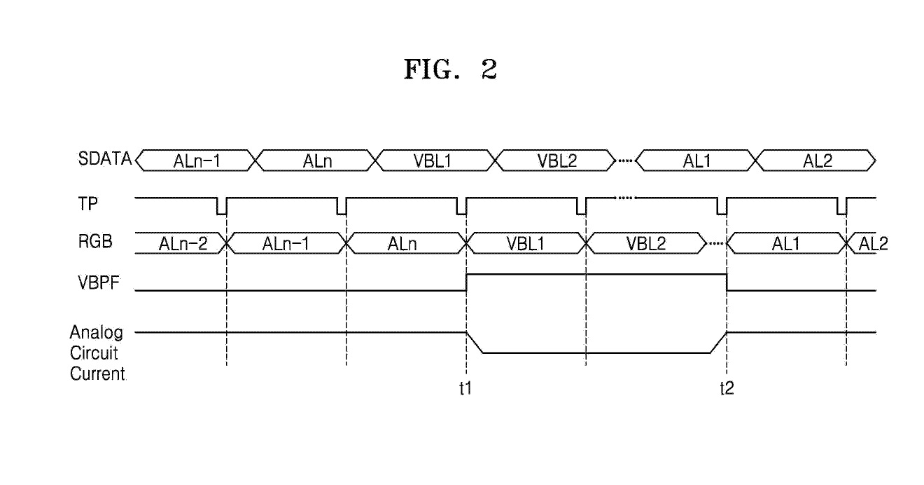

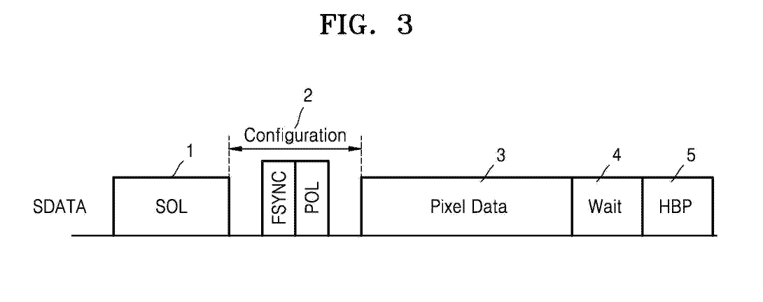

FIG. 2 is a timing diagram of an example of a signal waveform of the source driver 100 of FIG. 1. FIG. 2 illustrates a case in which pixel data RGB and a source driver control signal CNT1 are received as a data packet type. FIG. 3 shows a data packet of FIG. 2.

Referring to FIG. 2, data packets SDATA corresponding to respective lines of a frame may be sequentially transmitted. The data packets SDATA may include lines ALn−1, ALn, AL1, and AL2 (hereinafter, referred to as active lines), which may correspond to respective horizontal lines of an image frame of a display panel, and data regarding vertical blank lines VBL1 and VBL2, which may correspond to horizontal lines of the vertical blank section. After a data packet SDATA corresponding to a final active line ALn of the current frame is transmitted and before a first active line AL1 of the next frame is transmitted, data packets SDATA corresponding to the vertical blank lines VBL1 and VBL2 may be transmitted.

Referring to FIG. 3, the data packet SDATA may include a line start field 1, a configuration field 2, a pixel data field 3, a standby field 4, and a horizontal blank field 5.

The line start field 1 may indicate the start of each line of the image frame. The line start field 1 may include a clock code having a specific edge or pattern to enable discrimination between the line start field 1 and the horizontal blank field 5 of the previous line of the current image frame or enable discrimination between the line start field 1 and the vertical blank section between the current image frame and the previous image frame. Further, as shown in FIG. 3, the line start field 1 may include a line start signal SOL.

Configuration data for controlling the source driver 100 may be written in the configuration field 2. The configuration data may include a frame synchronous signal FSYNC, a polarity control signal POL, and a bias control signal. The frame synchronous signal FSYNC may be activated when a data packet corresponding to the final active line ALn of the image frame is transmitted and indicates that the transmitted data packet is data regarding the final active line of the image frame. The source driver 100 may receive the activated frame synchronous signal FSYNC and detect the vertical blank section starting after the current data packet is transmitted.

Pixel data to be indicated in units of respective lines of the display panel may be written in the pixel data field 3. The standby field 4 may be a section allocated for the source driver 100 to ensure a time required to receive and store pixel data RGB. For example, the standby field 4 may have a bit number corresponding to the time required for the source driver 100 to receive the pixel data RGB and store the pixel data RGB in the data latch unit 122.

The horizontal blank field 5 may be a section allocated for the source driver 100 to ensure a time required to drive the display panel based on the pixel data RGB. For example, the horizontal blank field 5 may have a bit number corresponding to the time required for the source driver 100 to convert the pixel data RGB stored in the data latch unit 122 into a gradation voltage and apply the gradation voltage to the display panel. The horizontal blank field 5 may include clock codes having an edge with a specific direction or a specific pattern to enable discrimination between the line start field 1 and the horizontal blank field 5.

Referring back to FIG. 2, a horizontal line driving section of the display panel may be determined based on the load signal TP. For example, as shown, a section between a rising edge of the load signal TP and the next rising edge thereof may be set as one horizontal line driving section. In this case, the load signal TP may be a signal synchronized with the vertical blank field 5 of the data packet SDATA. The pixel data RGB of the data packet SDATA received based on the load signal TP may be output from the data latch unit 122 and converted into a gradation voltage, and the gradation voltage may be applied to the display panel.

The vertical blank signal VBPF may be activated after a time point t1 at which the final active line ALn of the frame is driven and before a time point t2 at which the first active line AL1 of the next frame is driven. As an example, the control logic 123 of the source driver 100 may determine the end of the frame based on the frame synchronous signal FSYNC included in the data packet SDATA corresponding to the final active line ALn of the image frame and determine the start of the next frame based on the line start signal SOL included in the packet data SDATA corresponding to the first active line AL1 of the next frame.

When the vertical blank signal VBPF is activated, as described above with reference to FIG. 1, the source driver 100 may operate in a power-down mode in which a static current of the analog circuit 110 is reduced.

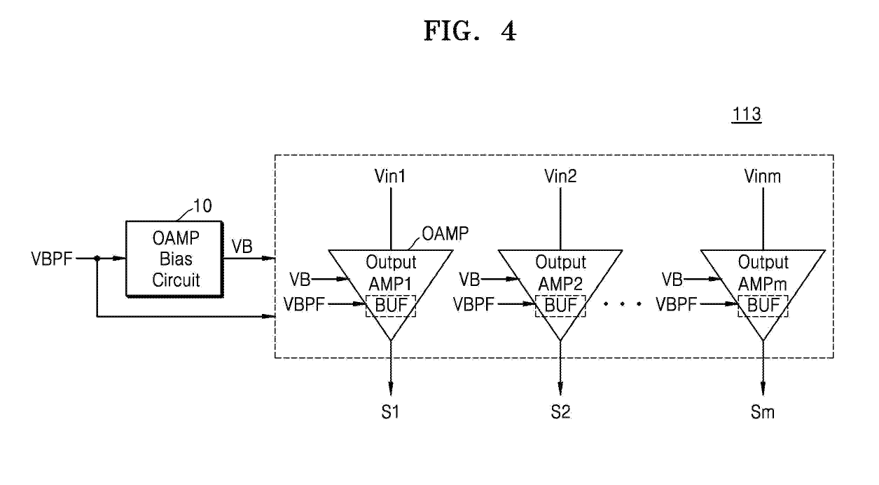

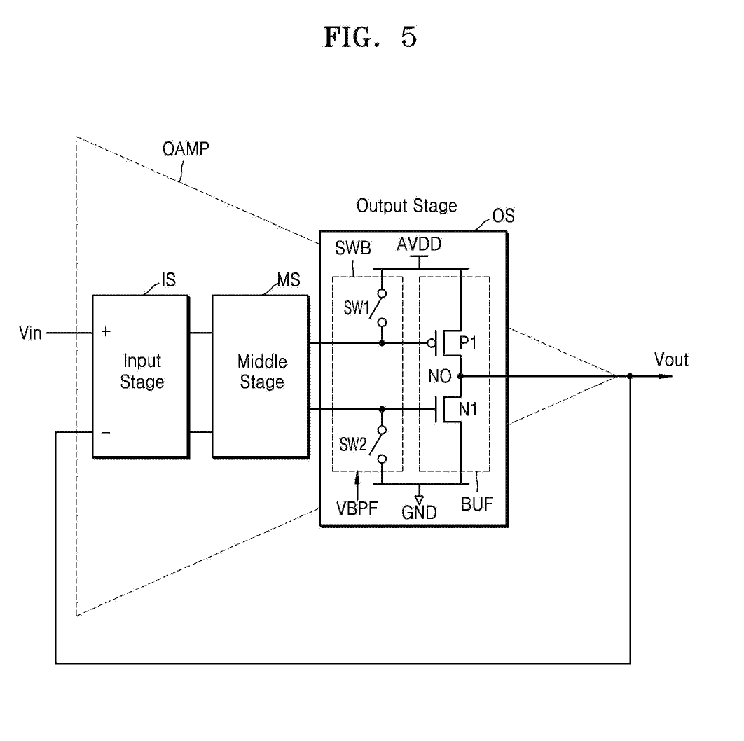

FIG. 4 is a schematic block diagram of the output buffer unit 113 of FIG. 1. FIG. 5 is a schematic circuit diagram of an output amplifier.

Referring to FIG. 4, the output buffer unit 113 may include a plurality of output amplifiers OAMP and an output amplifier (OAMP) bias circuit 10 configured to control biases of the plurality of output amplifiers OAMP.

The output amplifier (OAMP) bias circuit 10 may generate a bias signal VB for controlling the biases of the output amplifiers OAMP and provide the bias signal VB to the plurality of output amplifiers OAMP.

The plurality of output amplifiers OAMP may receive selected gradation voltages corresponding to pixel data as input signals Vin1 to Vinm, buffer the selected gradation voltages, and output the buffered voltages to the source lines S1 to Sm of the display panel. In this case, a slew rate of each of the output amplifiers OAMP may be controlled according to a level of the bias signal VB, for example, a voltage or current level.

A static current of each of the plurality of output amplifiers OAMP may be reduced in the vertical blank section. An operation of an output buffer BUF included in each of the output amplifiers OAMP may be cut off in response to the vertical blank signal VBPF, and the bias current of each of the output amplifiers OAMP may be reduced.

Referring to FIG. 5, each of the output amplifiers OAMP may include an input stage IS, a middle stage MS, and an output stage OS, and an output voltage Vout may be fed back as an inverted input (−) to obtain a unity gain.

The input stage IS may externally receive an input signal Vin and have a differential mode input structure. The middle stage MS may receive and amplify signals output from the input stage IS. For example, the middle stage MS may have a folded cascode structure and perform operations, such as a current mirroring operation.

The output stage OS may include an output buffer BUF configured to output an output voltage Vout and a switch block SWB configured to control the output buffer BUF. The output buffer BUF may include a PMOS transistor P1 and an NMOS transistor N1 and output the output voltage Vout through an output node NO based on signals from the middle stage MS.

The switch block SWB may control operations of the output buffer BUF based on the vertical blank signal VBPF. To this end, the switch block SWB may include a first switch SW1 connected between a gate of a PMOS transistor P1 of the output buffer BUF and a first power supply voltage AVDD and a second gate switch SW2 connected between a gate of the NMOS transistor N1 of the output buffer BUF and a second power supply voltage GND. Each of the first and second switches SW1 and SW2 may be embodied by a switching circuit, such as a transmission gate. The first and second switches SW1 and SW2 may be turned on or off in response to the vertical blank signal VBPF. When the vertical blank signal VBPF is activated, the first and second switches SW1 and SW2 may be turned on so that power supply voltages AVDD and GND can be applied to the PMOS and NMOS transistors P1 and N1. Accordingly, the PMOS and NMOS transistors P1 and N1 may be turned off to block operations of the output buffer BUF.

As described above, the output buffer BUF may be controlled to perform pull-up and pull-down operations in a normal mode, and the operations of the output buffer BUF may be blocked in a power-down mode, namely, when the vertical blank signal VBPF is activated.

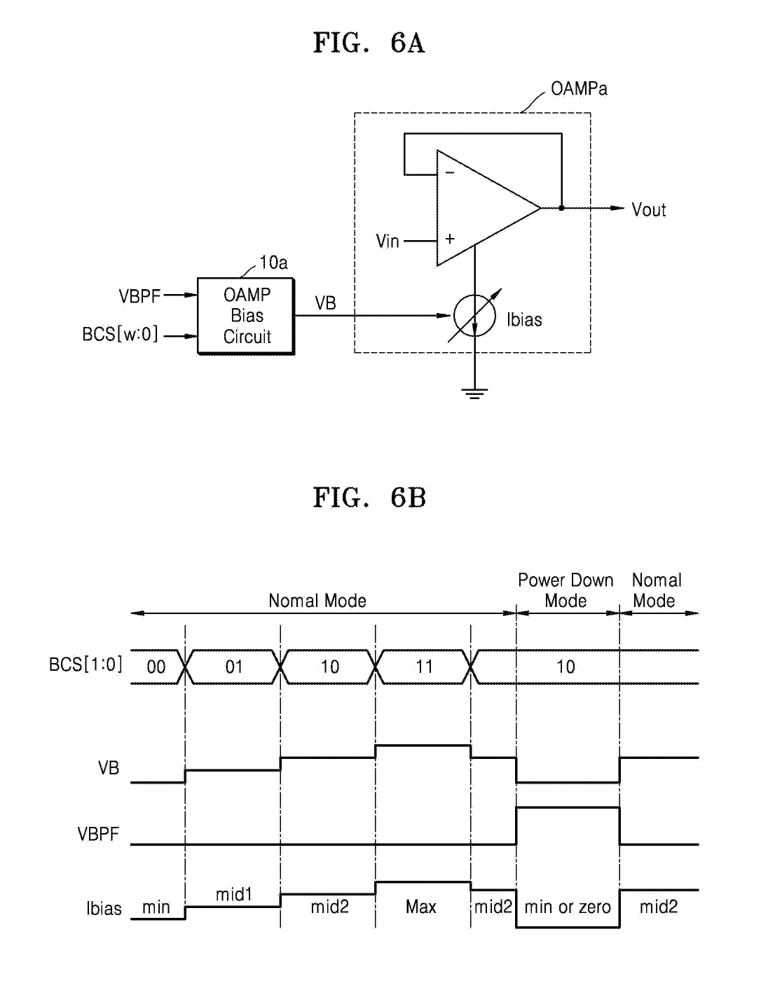

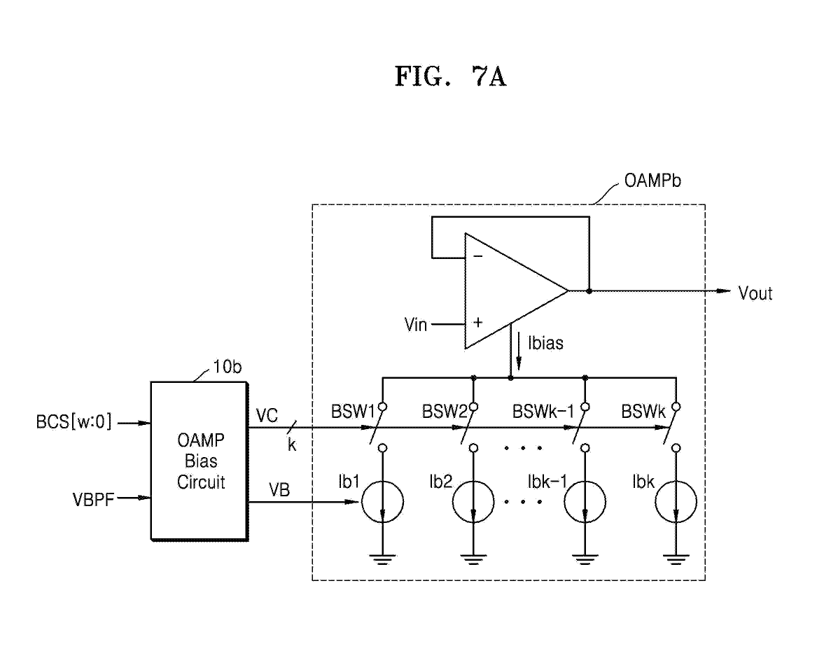

FIG. 6A is a diagram of an example in which the output buffer unit 113 of FIG. 4 controls a bias current of an output amplifier, and FIG. 6B is a timing diagram of signals of FIG. 6A. Only one output amplifier OAMPa is illustrated for brevity. Therefore, operations of the plurality of output amplifiers OAMP of FIG. 5 are substantially the same as operations of the output amplifier OAMPa of FIG. 6A.

Referring to FIGS. 6A and 6B, an output amplifier bias circuit 10a may receive a bias control signal BCS[w:0] and a vertical blank signal VBPF, and generate the bias signal VB based on the bias control signal BCS[w:0] and a vertical blank signal VBPF. The bias control signal BCS[w:0] may be a signal set to control a slew rate of the output amplifier OAMPa under a load condition of a source line of a display panel. The bias control signal BCS[w:0] may be included in the source driver control signal (refer to CNT1 in FIG. 1) and received. The bias control signal BCS[w:0] may be a multi-bit signal.

The output amplifier bias circuit 10a may generate a bias signal VB having various levels in response to the bias control signal BCS[w:0]. A level of the bias signal VB may be varied by changing an internal resistance of the output amplifier bias circuit 10a in response to the bias control signal BCS[w:0]. A bias current Ibias of the output amplifier OAMPa may be controlled according to the level of the bias signal VB.

As shown in FIG. 6B, when the bias control signal BCS[w:0] is a two-bit signal BCS[1:0], the bias signal VB output by the output amplifier bias circuit 10a may be controlled in four stages. In a normal mode, the bias signal VB and the bias current Ibias of the output amplifier OAMPa may vary according to a data value of the bias control signal BCS[1:0]. Although a case in which the data value of the bias control signal BCS[1:0] increases is illustrated in FIG. 6B for brevity, the bias control signal BCS[1:0] may maintain a value set at an initial operation, during the driving of the display panel.

In a power-down mode, when the vertical blank signal VBPF is activated, the bias signal VB may be set to the lowest level irrespective of the set data value of the bias control signal BCS[1:0], so that the bias current Ibias of the output amplifier OAMPa may be the smallest. During the vertical blank section, the output amplifier OAMPa may not drive the source line of the display panel. Accordingly, the bias current Ibias of the output amplifier OAMPa may be reduced to reduce power consumption. The bias current Ibias may not be completely cut off but set as the smallest current. Thus, power consumption may be reduced in the vertical blank section, and the output amplifier OAMPa may rapidly return to normal operations after the vertical blank section. In other exemplary embodiments, the bias current Ibias of the output amplifier OAMPa may be completely cut off in the vertical blank section depending on characteristics or driving conditions of the output amplifier OAMPa.

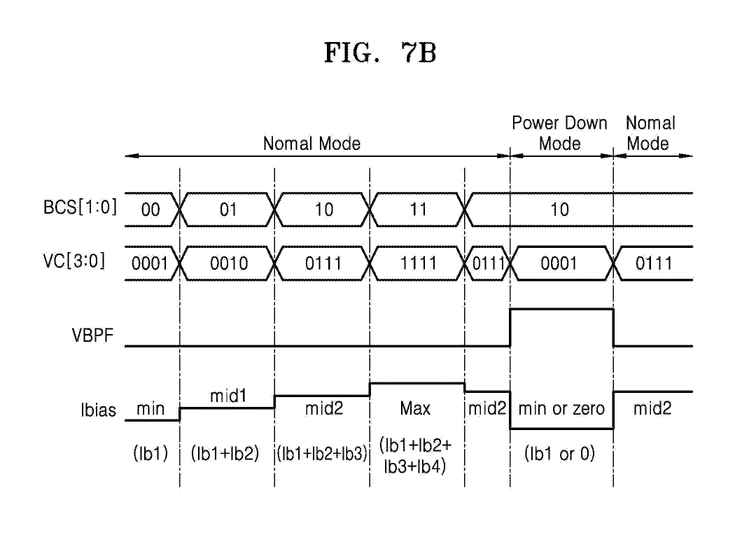

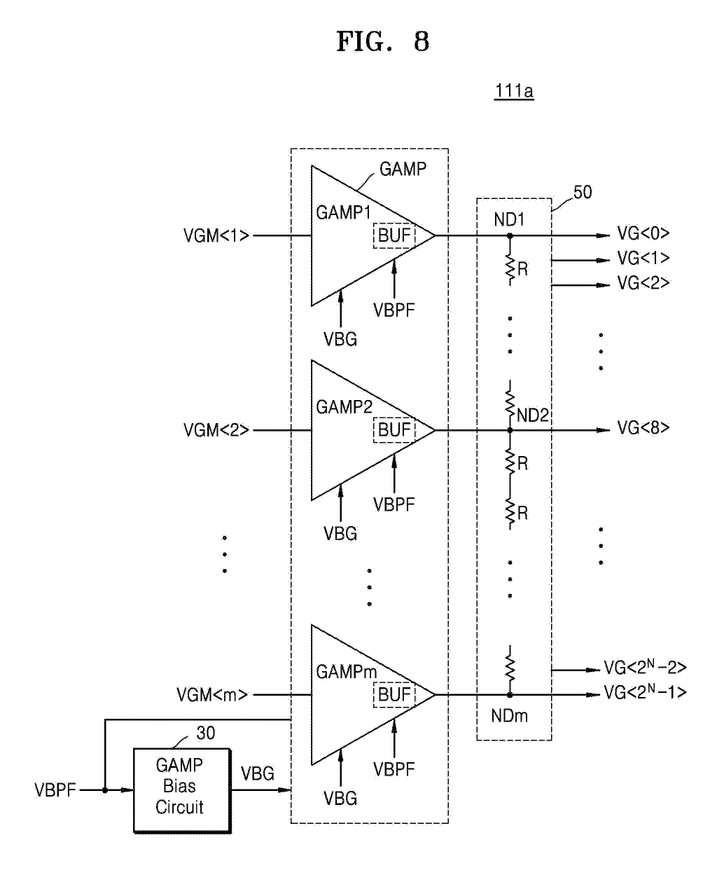

FIG. 7A is a diagram of another example in which the output buffer unit 113 of FIG. 4 controls a bias current of an output amplifier. FIG. 7B is a timing diagram of signals of FIG. 7A. Only one output amplifier OAMPb is illustrated for brevity. Operations of the output amplifiers OAMP of FIG. 4 are substantially the same as operations of the output amplifier OAMPb of FIG. 7A.

Referring to FIG. 7A, the output amplifier bias circuit 10b may receive a bias control signal BCS[w:0] and a vertical blank signal VBPF and generate a bias signal VB and a selection signal VC based on the bias control signal BCS[w:0] and the vertical blank signal VBPF. The bias signal VB may provide a reference bias current to the output amplifier OAMPb. The selection signal VC may be a multi-bit signal. A value of the selection signal VC may vary according to a data value of the bias control signal BCS[w:0].

In the present exemplary embodiment, the output amplifier OAMPb may include a plurality of bias current sources Ib1 to Ibk and a plurality of bias switches BSW1 to BSWk connected respectively to the bias current sources Ib1 to Ibk. The plurality of bias current sources Ib1 to Ibk and the plurality of bias switches BSW1 to BSWk may be provided at the input stage (refer to the input state IS in FIG. 5) of the output amplifier OAMPb. The plurality of bias current sources Ib1 to Ibk may be controlled in response to the bias signal VB and generate reference bias currents. The plurality of bias switches BSW1 to BSWk may be respectively turned on or off in response to bits of the selection signal VC. For example, the first bias switch BSW1 may be turned on or off in response to a first bit of the control signal VC, and the second bias switch BSW2 may be turned on or off in response to a second bit of the control signal VC. The whole bias current Ibias may vary depending on whether the bias switches BSW1 to BSWk are turned on or off.

FIG. 7B is a timing diagram of signals on the assumption that the output amplifier OAMPb includes four bias switches BSW1 to BSW4 and four bias current sources Ib1 to Ib4, and an output amplifier bias circuit 10b outputs a 4-bit selection signal VC[3:0] based on a bias control signal BCS[1:0] having a 2-bit signal. Referring to FIG. 7B, in a normal mode, a bias current Ibias may be controlled according to a set data value of the bias control signal BCS[1:0]. When the vertical blank signal VBPF is activated and the output buffer unit (refer to 113 in FIG. 4) enters a power-down mode, the output amplifier bias circuit 10b may output a selection signal VC (e.g., 0111) for controlling the bias current Ibias to be smallest, irrespective of the set data value of the bias control signal BCS[1:0]). Thus, one of the bias switches BSW1 to BSW4 may be turned on, and the smallest bias current may flow. In other exemplary embodiments, when the output buffer unit 113 enters the power-down mode, the output amplifier bias circuit 10b may output a selection signal VC having such a level as to turn off the bias switches BSW1 to BSW4 (e.g., 0000), and cut off the bias current Ibias of the output amplifier OAMPb.

An example in which the bias current of the output amplifier OAMP of FIG. 4 is minimized or cut off in the vertical blank section is described above with reference to FIGS. 6A through 7B. However, the inventive concept is not limited thereto, and the above-described methods may be variously changed.

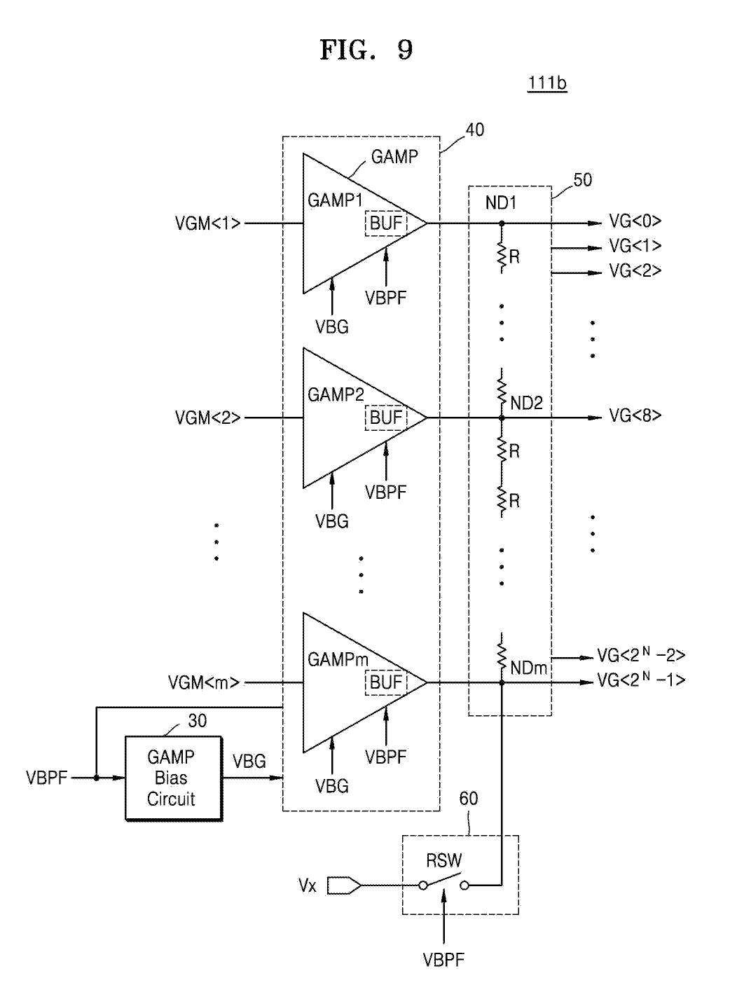

FIG. 8 is a block diagram of a gamma block 111a as an example of the gamma block 111 of FIG. 1.

Referring to FIG. 8, the gamma block 111a may include a plurality of gamma amplifiers GAMP, a gamma amplifier bias circuit 30, and a voltage divider 50.

The plurality of gamma amplifiers GAMP may respectively receive gamma reference voltages VGM<1> to VGM<m> and buffer and output the received gamma reference voltages VGM<1> to VG<m>. The gamma reference voltages VGM<1> to VGM<m> may be applied from the outside of the source driver (refer to 100 in FIG. 1) or generated in the source driver 100 and provided.

The gamma amplifier bias circuit 30 may generate a bias signal VBG for controlling biases of the gamma amplifiers GAMP and provide the bias signal VBG to the plurality of gamma amplifiers GAMP.

The voltage divider 50 may be embodied by a resistor column including a plurality of resistors R connected in series, voltage-divide gamma reference voltages VGM<1> to VGM<m> buffered and output by the plurality of gamma amplifiers GAMP, and generate a plurality of gradation voltages VG<0> to VG<2N−1>.

FIG. 8 illustrates a case in which the voltage divider 50 generates a set of 2N gradation voltages VG<0> to VG<2N−1>. However, as described above with reference to FIG. 1, when the source driver (refer to 100 in FIG. 1) drives an LCD panel, an LC source driver has to generate 2N gradation voltages having a higher voltage level than a common voltage of the LCD panel and 2N gradation voltages having a lower voltage level than the common voltage. Accordingly, the gamma block 111a may further include the same configuration as shown in FIG. 8.

Each of the gamma amplifiers GAMP may have a similar structure to the output amplifier OAMP shown in FIG. 5. Accordingly, the output stage (refer to OS in FIG. 5) of the gamma amplifier GAMP may include an output buffer BUF and a switch block SWB. When the vertical blank signal VBPF is activated, the first and second switches SW1 and SW2 may be turned on so that power supply voltages AVDD and GND can be applied to PMOS and NMOS transistors P1 and N1. Accordingly, the PMOS and NMOS transistors P1 and N1 may be turned off so that operations of the output buffer BUF may be blocked, and the resistance divider 50 may be floated. Thus, in the vertical blank section, a static current of the gamma amplifier GAMP may be reduced, and a dynamic current thereof may be cut off.

Furthermore, when the activated vertical blank signal VBPF is received, operations of the gamma amplifier bias circuit 30 may be stopped in response to the activated vertical blank signal VBPF. Alternatively, the gamma amplifier bias circuit 30 may generate and output a gamma bias signal VBG for cutting off a bias current of the gamma amplifier GAMP. Accordingly, since the operations of the gamma amplifier GAMP are stopped, a static current of the gamma amplifier GAMP may be cut off.

As described above, by reducing or cutting off currents of the gamma amplifiers GAMP in response to the activated vertical blank signal VBPF, the gamma block 111a may operate in a power-down mode in the vertical blank section.

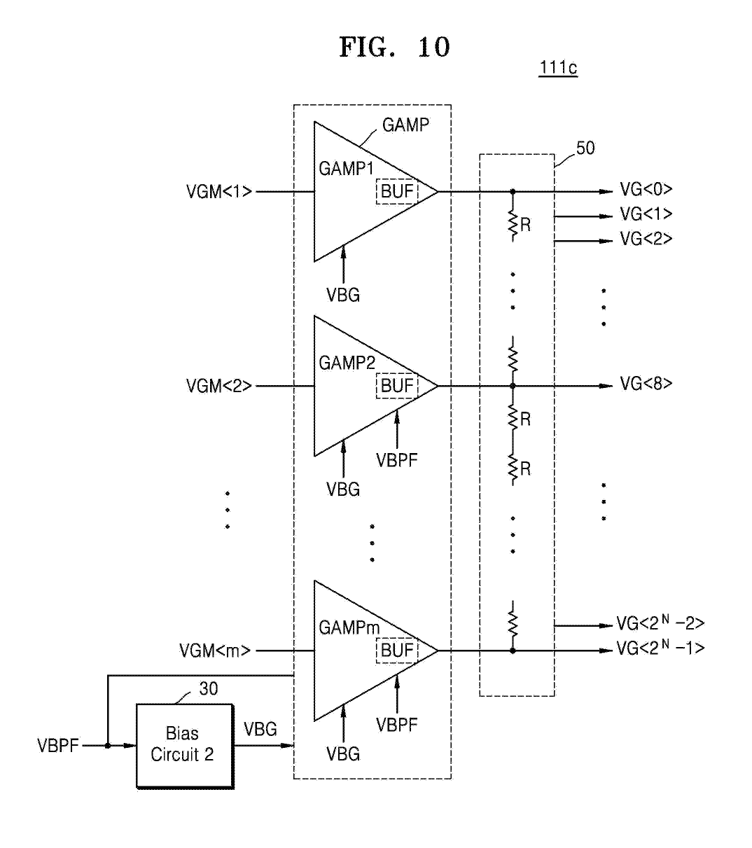

FIG. 9 is a block diagram of a gamma block 111b as another example of the gamma block 111 of FIG. 1.

Referring to FIG. 9, the gamma block 111b may include a plurality of gamma amplifiers GAMP, a gamma amplifier bias circuit 30, a voltage divider 50, and a switch 60.

As compared with the gamma block 111a of FIG. 8, the gamma block 111b of FIG. 9 may further include the switch 60 connected to the voltage divider 50. One terminal of the switch 60 may be connected to one of nodes ND1 to NDm of the voltage divider 50, and a predetermined voltage Vx may be applied to the other terminal of the switch 60. For example, the predetermined voltage Vx may be one of a plurality of gamma reference voltages VGM<1> to VGH<m>. Alternatively, the predetermined voltage VX may be one of a plurality of power supply voltages applied to the gamma block 111b, for example, one of a first power supply voltage AVDD, a second power supply voltage GND, and a third power supply voltage HAVDD.

The switch 60 may be turned on in response to an activated vertical blank signal VBPF. Accordingly, even if operations of output buffers BUF of the gamma amplifiers GAMP are blocked in response to the activated vertical blank signal VBPF, the voltage divider 50 may be prevented from being floated by applying the predetermined voltage Vx to the voltage divider 50. In this case, all gradation voltages VG<0> to VG<2N−1> may be output at the same voltage level as the predetermined voltage Vx.

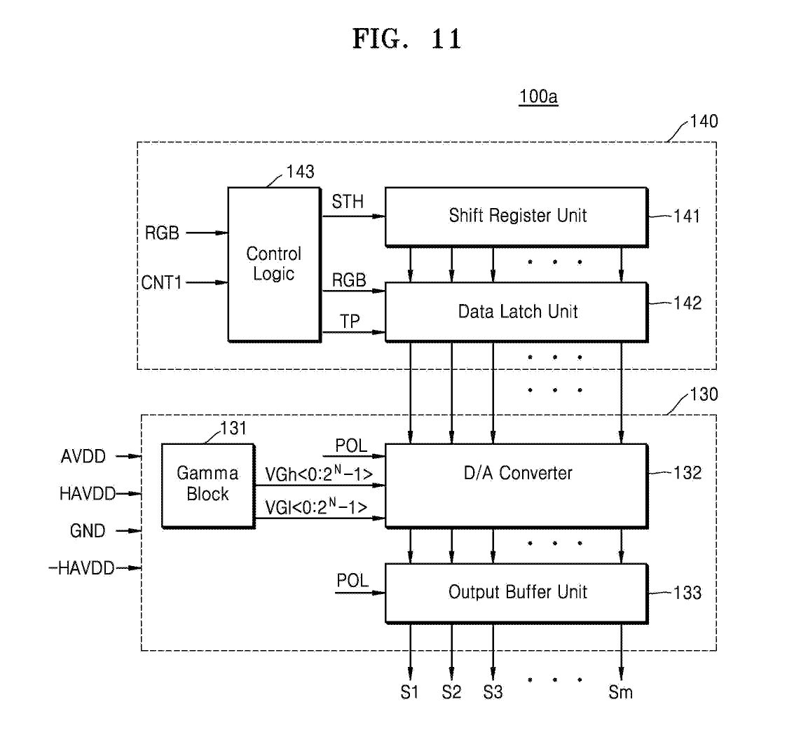

FIG. 10 is a block diagram of a gamma block 111c as another example of the gamma block 111 of FIG. 1.

Referring to FIG. 10, the gamma block 111c may include a plurality of gamma amplifiers GAMP, a gamma amplifier bias circuit 30, and a voltage divider 50. Since the gamma block 111c of FIG. 10 is similar to the gamma block 111a of FIG. 8, repeated descriptions will be omitted.

In the gamma block 111c of FIG. 10, at least one of the plurality of gamma amplifiers GAMP may not block operations of an output buffer BUF in response to an activated vertical blank signal VBPF. Therefore, at least one of the plurality of gamma amplifiers GAMP may normally operate even in a vertical blank section. In other words, in the vertical blank section, a gamma reference voltage buffered and output by the at least one gamma amplifier GAMP may be applied to the voltage divider 50 to prevent the voltage divider 50 from being floated. In one exemplary embodiment, a first gamma amplifier GAMP1 configured to buffer and output a first gamma reference voltage VGM<1> may normally operate in the vertical blank section. Since the first gamma reference voltage VGM<1> is equal to a 0 gradation voltage VG<0>, all gradation voltages VG<0> to VG<2N−1> may be output at the same level as the 0 gradation voltage VG<0>.

As described above, in the source driver 100 according to the exemplary embodiment of the inventive concept, the analog circuit 110 may operate in a power-down mode in a non-driving section, such as the vertical blank section. In response to the vertical blank signal VBPF, operations of output buffers of the amplifiers of the analog circuit 110 may be controlled and bias currents of the amplifiers may be controlled. Thus, a static current of the analog circuit 110 may be reduced in the vertical blank section. Accordingly, power consumption of the source driver 100 may be reduced.

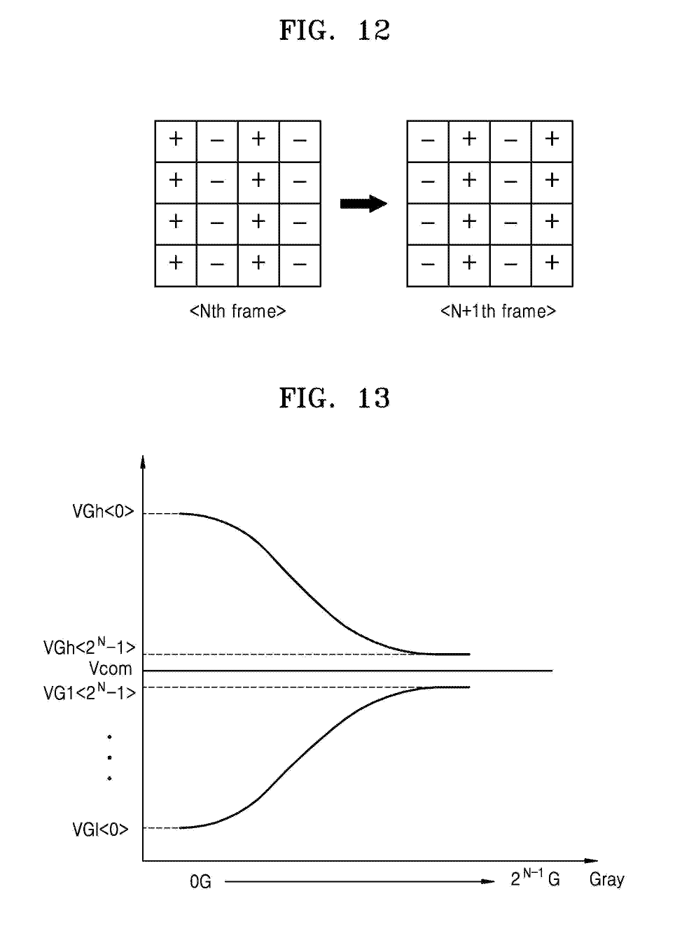

FIG. 11 is a block diagram of a source driver 100a according to another exemplary embodiment of the inventive concept.

Referring to FIG. 11, the source driver 100a may include a digital circuit 140 configured to receive and store digital-signal-type pixel data RGB and an analog circuit 130 configured to convert the pixel data RGB into analog-signal-type gradation voltages and output the gradation voltages to source lines S1 to Sm of a display panel.

The digital circuit 140 may include a shift register unit 141 and a data latch unit 142 and further include a control logic 143. The analog circuit 130 may include a gamma block 131, a DAC 132, and an output buffer unit 133. Since basic operations of respective components of the digital circuit 140 and the analog circuit 130 are similar to those of the respective components of the digital circuit 120 and the analog circuit 110 of the source driver 100 of FIG. 1, repeated descriptions thereof are omitted.

In the source driver 100a of the exemplary embodiment, the analog circuit 130 may operate with the application of a first power supply voltage AVDD, a second power supply voltage GND, and a third power supply voltage HAVDD. Among the power supply voltages, namely, the first power supply voltage AVDD, the third power supply voltage HAVDD, and the second power supply voltage GND, applied to the analog circuit 130, the first power supply voltage AVDD may have the highest voltage level and the second power supply voltage GND may have the lowest voltage level. The second power supply voltage GND may be a ground voltage. The third power supply voltage HAVDD may have a voltage level between the first power supply voltage AVDD and the second power supply voltage GND. As an example, a voltage level of the third power supply voltage HAVDD may be about ½ a voltage level of the first power supply voltage AVDD. Alternatively, the third power supply voltage HAVDD may have the same voltage level as a power supply voltage applied in common to pixels of the display panel (hereinafter, referred to as a common voltage).

In other exemplary embodiments, the analog circuit 130 of the source driver 100a may operate with the application of a second power supply voltage GND, a third power supply voltage HAVDD, and a fourth power supply voltage −HAVDD. Among the power supply voltages, namely, third power supply voltage HAVDD, the second power supply voltage GND, and the fourth power supply voltage −HAVDD, applied to the analog circuit 130, the third power supply voltage HAVDD may have the highest voltage level and the fourth power supply voltage −HAVDD may have the lowest voltage level. The second power supply voltage GND may be a ground voltage. The third power supply voltage HAVDD may be a positive voltage, and the fourth power supply voltage −HAVDD may be a negative voltage. The fourth power supply voltage −HAVDD may be a power supply voltage having the same magnitude as the third power supply voltage HAVDD and an opposite sign to the third power supply voltage HAVDD.

Hereinafter, an example in which the analog circuit 130 of the source driver 100a operates with the application of the first power supply voltage AVDD, the second power supply voltage GND, and the third power supply voltage HAVDD will be described. When the analog circuit 130 operates with the application of the second power supply voltage GND, the third power supply voltage HAVDD, and the fourth power supply voltage −HAVDD, it will be understood by one of ordinary skill that in the later descriptions that the first power supply voltage AVDD may be replaced by the third power supply voltage HAVDD, the second power supply voltage GND may be replaced by the fourth power supply voltage −HAVDD, and the third power supply voltage HAVDD may be replaced by the second power supply voltage GND.

Next, referring to FIG. 11, the gamma block 131 may operate with the application of the first power supply voltage AVDD, the second power supply voltage GND, and the third power supply voltage HAVDD. The gamma block 131 may generate a plurality of high gradation voltages VGh<0: 2N−1> and a plurality of low gradation voltages VG1<0: 2N−1> and provide the generated voltages to the DAC 132.

The DAC 132 may select and output one of the high gradation voltages VGh<0: 2N−1> and the low gradation voltages VG1<0: 2N−1> based on the pixel data RGB and a polarity control signal POL.

The output buffer unit 133 may operate with the application of the first power supply voltage AVDD, the second power supply voltage GND, and the third power supply voltage HAVDD. The output buffer unit 133 may buffer and output each of the gradation voltages output by the DAC 132. In this case, the output buffer unit 133 may include a plurality of output amplifiers, each of which may selectively operate as a positive output amplifier or a negative output amplifier based on the polarity control signal POL.

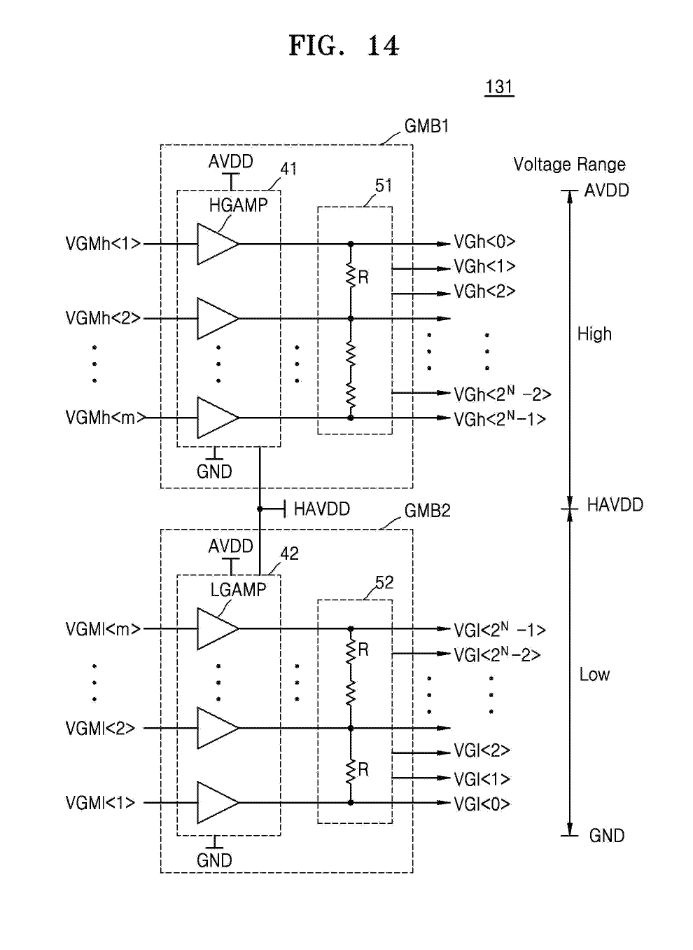

To improve resolution and prevent the degradation of pixels, the display panel, such as an LC panel, may be driven by inverting polarity in units of frames or in units of columns of pixels, as shown in FIG. 12. Alternatively, the display panel may be driven by inverting polarity in units of frames or in units of adjacent pixels. When a gradation voltage having a higher voltage level than a common voltage is applied to the pixels, the pixels may have a positive polarity (+), while when a gradation voltage having a lower voltage level than the common voltage is applied to the pixels, the pixels may have a negative polarity (−).

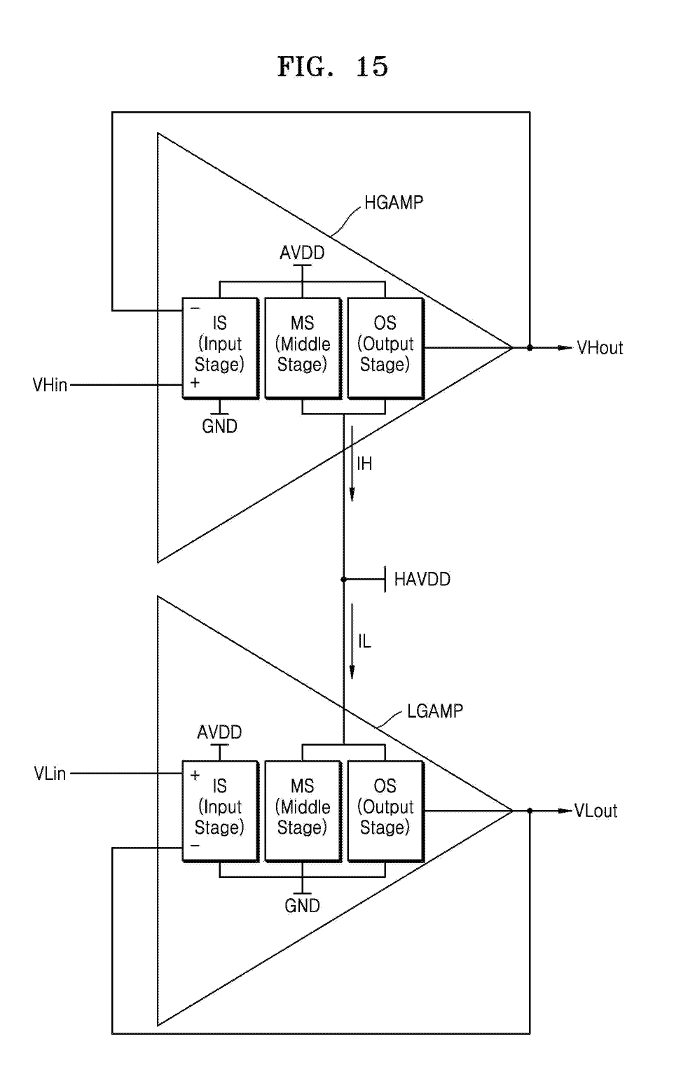

To enable the above-described polarity inversion operation, as shown in FIG. 13, the source driver 100a may generate high gradation voltages VGh<0: 2N−1> having a higher voltage level than a common voltage VCOM and low gradation voltages VG1<0: 2N−1> having a lower voltage level than the common voltage VCOM, and output one of the high gradation voltages VGh<0: 2N−1> or the low gradation voltages VG1<0: 2N−1> based on the corresponding pixel data RGB and the polarity control signal POL. In this case, the high gradation voltages VGh<0: 2N−1> may have a voltage level between the first power supply voltage AVDD and the third power supply voltage HAVDD, while the low gradation voltages VG1<0: 2N−1> may have a voltage level between the third power supply voltage HAVDD and the second power supply voltage GND. As described above, since a voltage range of the high gradation voltages VGh<0: 2N−1> is distinguished from a voltage range of the low gradation voltages VG1<0: 2N−1>, circuit blocks of the analog circuit 130, which may participate in generating and outputting the high gradation voltages VGh<0: 2N−1>, may operate with the application of the first power supply voltage AVDD and the third power supply voltage HAVDD, while circuit blocks of the analog circuit 130, which may participate in generating and outputting the low gradation voltages VG1<0: 2N−1>, may operate with the application of the third power supply voltage HAVDD and the second power supply voltage GND. Accordingly, operating voltage ranges and current consumption of the circuit blocks included in the analog circuit 130 may be reduced, thereby reducing power consumption.

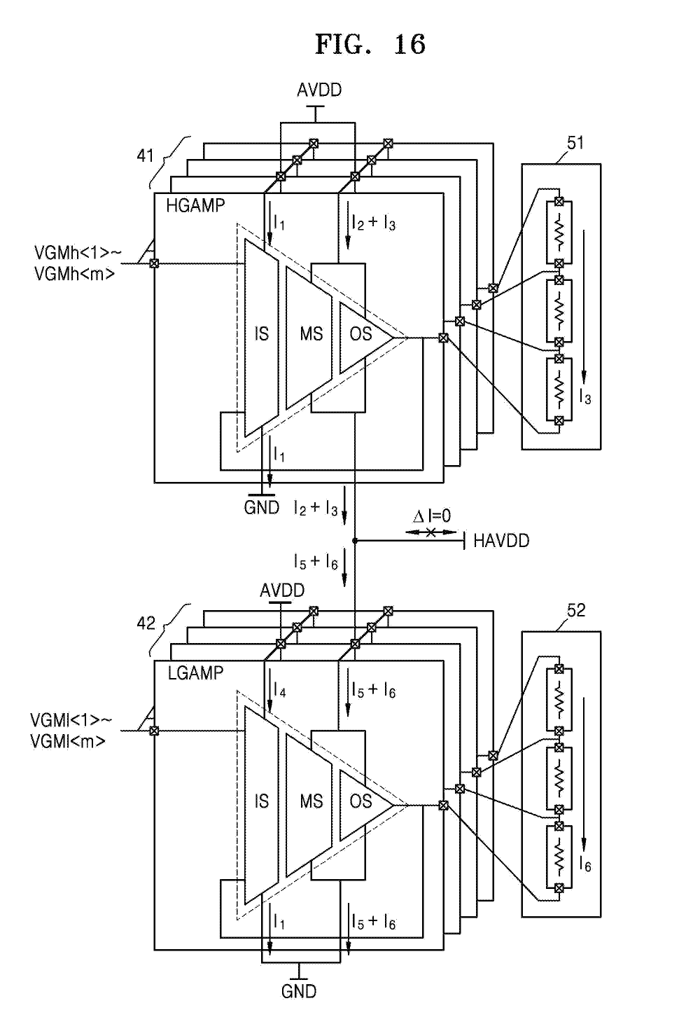

FIG. 14 is a schematic block diagram of the gamma block 131 of FIG. 11.

Referring to FIG. 14, the gamma block 131 may include a first gamma block GMB1 configured to generate high gradation voltages VGh<0: 2N−1> and a second gamma block GMB2 configured to generate low gradation voltages VG1<0: 2N−11>.

The first gamma block GMB1 may generate high gradation voltages VGh<0: 2N−1> based on high gamma reference voltages VGMh<1:M>. The first gamma block GMB1 may include a first amplifier 41 including a plurality of high gamma amplifiers HGAMP and a first voltage divider 51 configured to divide a voltage output by the first amplifier 41 and generate high gradation voltages VGh<0: 2N−1>.

The second gamma block GMB2 may generate low gradation voltages VG1<0: 2N−1> based on low gamma reference voltages VGM1<1:M>. The second gamma block GMB2 may include a second amplifier 42 including a plurality of low gamma amplifiers LGAMP and a second voltage divider 52 configured to divide a voltage output by the second amplifier 42 and generate low gradation voltages VG1<0: 2N−1>.

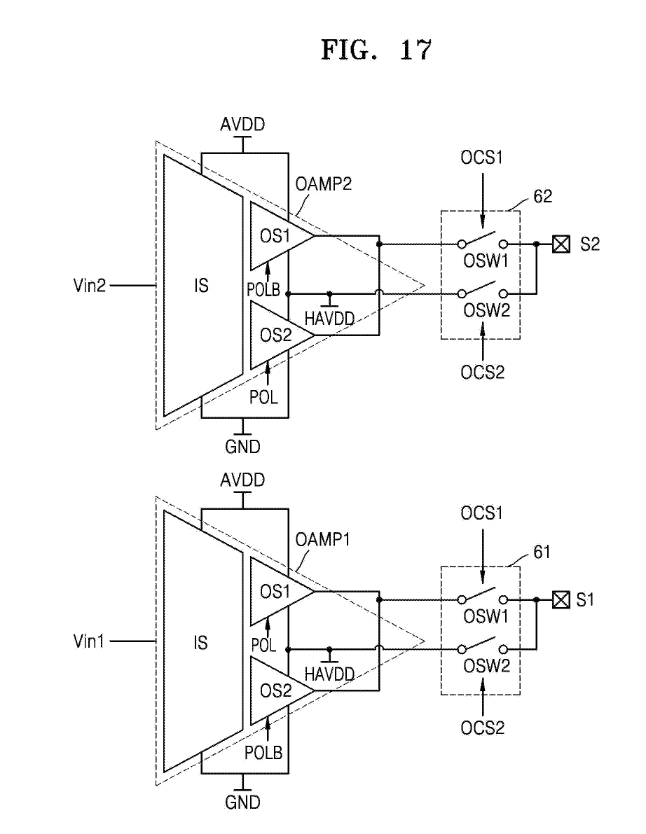

The high gamma amplifier HGAMP of the first gamma block GMB1 may have a similar circuit configuration to that of the low gamma amplifier LGAMP of the second gamma block GMB2. However, since voltages output by the high gamma amplifier HGAMP and the low gamma amplifier LGAMP have different voltage ranges, as shown in FIG. 15, different power supply voltages may be applied to output stages included in the high gamma amplifier HGAMP and the low gamma amplifier LGAMP.

FIG. 15 is a diagram of power supply voltages applied to the high gamma amplifier HGAMP and the low gamma amplifier LGAMP of FIG. 14. In FIG. 15, one high gamma amplifier HGAMP and one low gamma amplifier LGAMP are illustrated for brevity.

Referring to FIG. 15, each of the high gamma amplifier HGAMP and the low gamma amplifier LGAMP may include an input stage IS, a middle stage MS, and an output stage OS. The middle stage MS may be excluded according to the type of an amplifier. Since output voltages VHout and VLout are fed back as inverted inputs (−) into the high gamma amplifier HGAMP and the low gamma amplifier LGAMP, the high gamma amplifier HGAMP and the low gamma amplifier LGAMP may have a unity gain.

The input stage IS may externally receive an input signal and have a differential-mode input structure. The middle stage MS may receive and amplify signals output from the input stage IS. The output stage OS may generate output voltages VHout and VLout based on the signals output from the middle stage MS.

The first power supply voltage AVDD may be applied in common as upper power supply voltages of the respective stages IS, MS, and OS of the high gamma amplifier HGAMP. Also, the third power supply voltage HAVDD may be applied as lower power supply voltages of the middle stage MS and the output stage OS, and the second power supply voltage GND may be applied as a lower power supply voltage of the input stage IS.

The second power supply voltage GND may be applied in common as lower power supply voltages of the respective stages IS, MS, and OS of the low gamma amplifier LGAMP. The third power supply voltage HAVDD may be applied as upper power supply voltages of the middle stage MS and the output stage OS, and the first power supply voltage AVDD may be applied as an upper power supply voltage of the input stage IS.

Since an output voltage of the high gamma amplifier HGAMP has a different voltage range from an output voltage of the low gamma amplifier LGAMP, as described above, power supply voltages having different voltage levels may be applied to the middle stages MS and the output stages OS of the high gamma amplifier HGAMP and the low gamma amplifier LGMAP in consideration of the voltage ranges of the output voltages.

Offset characteristics of an amplifier may be affected by a voltage range of an input stage. As the voltage range of the input voltage widens, the amplifier may have better offset characteristics. Accordingly, the first power supply voltage AVDD and the second power supply voltage GND may be applied to the input stages IS of the high gamma amplifier HGAMP and the low gamma amplifier LGAMP so that the input stages IS of the high gamma amplifier HGAMP and the low gamma amplifier LGAMP can have the widest possible voltage range. However, the inventive concept is not limited thereto, and the same power supply voltage as a power supply voltage applied to the middle stage MS and the output stage OS may be applied to each of the input stages IS of the high gamma amplifier HGAMP and the low gamma amplifier LGAMP. That is, the high gamma amplifier HGAMP may operate with the application of the first power supply voltage AVDD and the third power supply voltage HAVDD, while the low gamma amplifier LGAMP may operate with the application of the third power supply voltage HAVDD and the second power supply voltage GND.

In a related art, both the high gamma amplifier HGAMP and the low gamma amplifier LGAMP operate with the application of the first power supply voltage AVDD and the second power supply voltage GND. However, according to the exemplary embodiments of the inventive concept, operating voltage ranges of the middle stage MS and the output stage OS of the high gamma amplifier HGAMP and the low gamma amplifier LGAMP may be narrowed to reduce power consumption. Also, the third power supply voltage HAVDD may be applied as the lower power supply voltage of the high gamma amplifier HGAMP and applied as the upper power supply voltage of the low gamma amplifier LGAMP. Thus, as shown in FIG. 15, a sink current IH used in the high gamma amplifier HGAMP may be reused as a source current IL in the low gamma amplifier LGAMP, so that the entire current consumption of the gamma block 131 can be reduced.

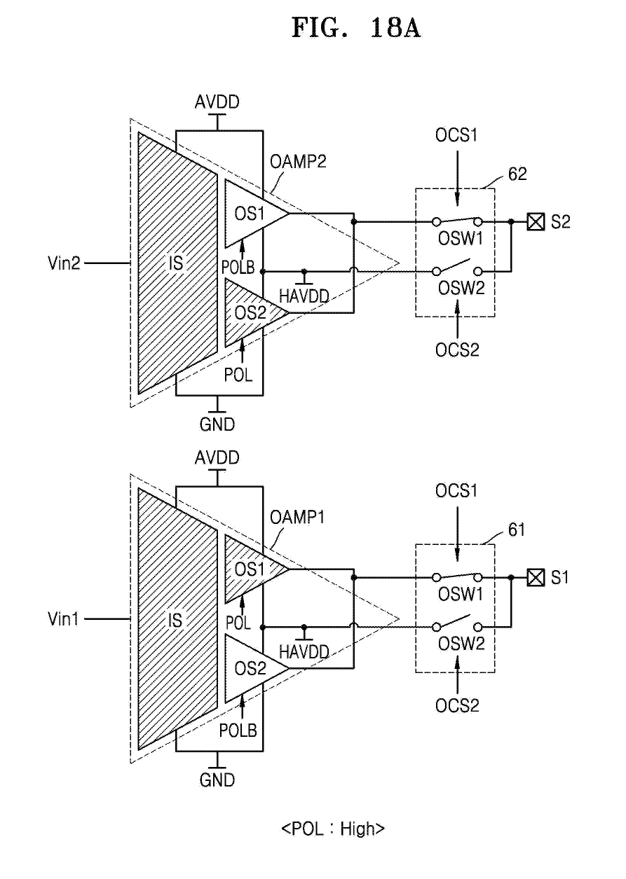

FIG. 16 is a diagram for explaining reuse of current in the gamma block 131 of FIG. 11.

Referring to FIG. 16, current consumed by the first amplifier 41 including a plurality of high gamma amplifiers HGAMP may include a static current I1 of the input stage IS of each of the high gamma amplifiers HGAMP and a static current I2 and a dynamic current I3 of the middle stage MS and the output stage OS thereof.

Current consumed by the second amplifier 42 including a plurality of low gamma amplifiers LGAMP may include a static current I4 of the input stage IS of each of the low gamma amplifiers LGAMP and a static current I5 and a dynamic current I6 of the middle stage MS and the output stage OS thereof.

As shown in FIG. 16, current consumed by the middle stage MS and the output stage OS of each of the high gamma amplifiers HGAMP may be reused in the middle stage MS and the output stage OS of each of the low gamma amplifiers LGAMP. By symmetrically designing the high gamma amplifier HGAMP and the low gamma amplifier LGAMP, the sum of the consumption currents, namely, the static current I2 and the dynamic current I3, of each of the high gamma amplifiers HGAMP may be equal to the sum of the consumption currents, namely, the static current IS and the dynamic current I6, of each of the low gamma amplifiers LGAMP. Thus, the consumption currents, namely, the static current I2 and the dynamic current I3, of the high gamma amplifiers HGAMP may be reused in the low gamma amplifier LGAMP, and a sink current and a source current, which serve as a voltage source for providing the third power supply voltage HAVDD, substantially disappear. As a result, power consumption of the gamma block 131 may be reduced.

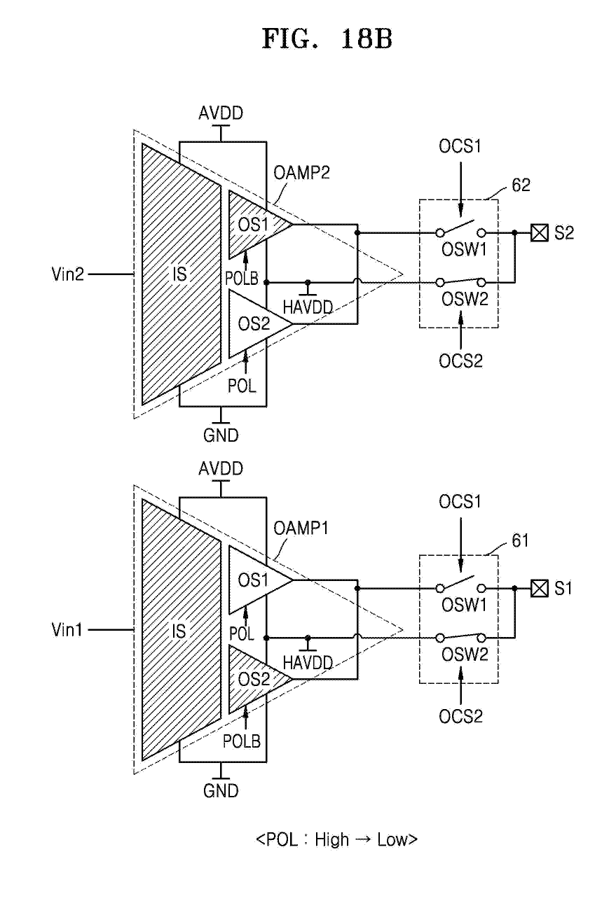

FIG. 17 is a schematic block diagram of the output buffer unit 133 of FIG. 11.

Referring to FIG. 17, the output buffer unit 133 may include a plurality of output amplifiers OAMP1 and OAMP2 and a plurality of switch units 61 and 62 which correspond to the output amplifiers OAMP1 and OAMP2. In FIG. 17, two output amplifiers OAMP1 and OAMP2 and two switch units 61 and 62 are illustrated for brevity.

Each of the output amplifiers OAMP1 and OAMP2 may include one input stage IS and two output stages OS1 and OS2. The first output stage OS1 may operate with the application of the first power supply voltage AVDD and the third power supply voltage HAVDD, and the second output stage OS2 may operate with the application of the third power supply voltage HAVDD and the second power supply voltage GND. The first power supply voltage AVDD may be a power supply voltage having the highest voltage level, the second power supply voltage GND may be a power supply voltage having the lowest voltage level, and the third power supply voltage HAVDD may be a power supply voltage having a voltage level between the first power supply voltage AVDD and the second power supply voltage GND. The third power supply voltage HAVDD may have ½ a voltage level of the first power supply voltage AVDD.

The first output stage OS1 and the second output stage OS2 may selectively operate in response to a polarity control signal POL. When the output amplifiers OAMP1 and OAMP2 buffer and output a high gradation voltage, the first output stage OS1 may be selected and operate. When the output amplifiers OAMP1 and OAMP2 buffer and output a low gradation voltage, the second output stage OS2 may be selected and output. An unselected output stage may not consume power because operations of the unselected output stage are blocked. Although an operating voltage range of each of the output amplifiers OAMP1 and OAMP2 is between the first power supply voltage AVDD and the second power supply voltage GND, since a substantial operating voltage range of the output amplifiers OAMP1 and OAMP2 is between the first power supply voltage AVDD and the third power supply voltage HAVDD or between the third power supply voltage HAVDD and the second power supply voltage GND, the operating voltage range of the output amplifiers OAMP1 and OAMP2 may be reduced. Accordingly, power consumption of the output buffer unit 133 may be reduced.

The switch units 61 and 62 may determine voltages applied to the source lines S1 and S2. Each of the switch units 61 and 62 may include a first output switch OSW1, which may be turned on or off in response to a first output control signal OCS, and a second output switch OSW2, which may be turned on or off in response to a second output control signal OSC2. When the first output switch OSW1 is turned on in response to an activated first output control signal OCS, output voltages of the output amplifiers OAMP1 and OAMP2 may be provided to the source lines S1 and S2. When the second output switch OSW2 is turned on in response to an activated second output control signal OCS2, the third power supply voltage HAVDD may be applied to the source lines S1 and S2. The first output control signal OCS1 and the second output control signal OCS2 may not be simultaneously activated, but may be complementary signals.

When the polarity control signal POL makes a transition, the second output control signal OCS2 may be activated for a predetermined period, and the first output control signal OCS1 may be inactivated for the predetermined period. When polarity is inverted, output stages operating in the output amplifiers OAMP1 and OAMP2 may be changed so that voltages having abnormal peaks can be output from the output amplifiers OAMP1 and OAMP2. Accordingly, during the inversion of polarity, abnormal outputs of the output amplifiers OAMP1 and OAMP2 may be prevented from being applied to the source lines S1 and S2 by turning off the first output switch OSW1 for a predetermined period. In this case, the second output switch OSW2 may be turned on so that the third power supply voltage HAVDD can be applied to the source lines S1 and S2 instead of the outputs of the output amplifiers OAMP1 and OAMP2. Since the third power supply voltage HAVDD has a middle voltage level between the high gradation voltage and the low gradation voltages, voltages of the source lines S1 and S2 may be changed by stages during the inversion of polarity. Thus, the burden of driving of the output amplifiers OAMP1 and OAMP2 may be reduced.

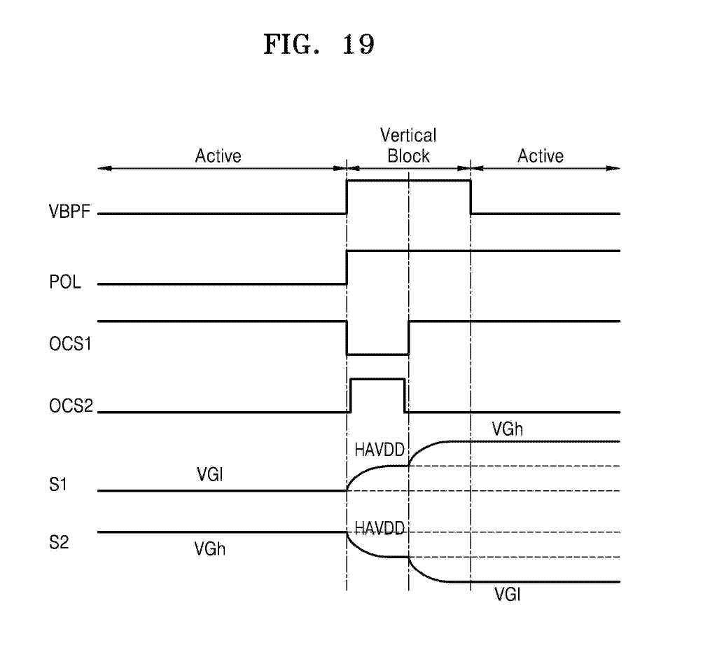

FIGS. 18A and 18B are diagrams for explaining operations of the output buffer unit 133 of FIG. 17 in response to the polarity control signal POL. Referring to FIG. 18A, when the polarity control signal POL is at a first level, for example, at a logic high level, the first output stage OS1 may operate in the first output amplifier OAMP1 and the second output stage OS2 may operate in the second output amplifier OAMP2. As described with reference to FIG. 12, the display panel may be driven in a column inversion manner to prevent the degradation of resolution and pixels. Accordingly, the output amplifiers OAMP1 and OAMP2 configured to drive two adjacent source lines S1 and S2 may output gradation voltages having different polarities. Thus, the first output stage OS1 may operate in the first output amplifier OAMP1. Conversely, the second output stage OS2 may operate in the second output amplifier OAMP2. In this case, the first output switch OSW1 may be turned on, and the second output switch OSW2 may be turned off. Thus, an output voltage of the first output stage OS1 of the first output amplifier OAMP1 may be provided to the first source line S1, while an output voltage of the second output stage OS2 of the second output amplifier OAMP2 may be provided to the second source line S2.

Referring to FIG. 18A, when the polarity control signal POL is at a second level, for example, at a logic low level, an output voltage of the second output stage OS2 of the first output amplifier OAMP1 may be provided to the first source line S1, and an output voltage of the first output stage OS1 of the second output amplifier OAMP2 may be provided to the second source line S2.

Referring to FIG. 18B, when the polarity control signal POL makes a transition from the first level (e.g., the logic high level) to the second level (e.g., the logic low level) the second output stage OS2 may operate in the first output amplifier OAMP1 and the first output stage OS1 may operate in the second output amplifier OAMP2. In this case, after the polarity control signal POL makes the transition, the first output switch OSW1 may be turned off and the second output switch OSW2 may be turned on for a predetermined amount of time, so that the third power supply voltage HAVDD may be applied to the source lines S1 and S2 instead of the output voltages of the output amplifiers OAMP1 and OAMP2.

When the polarity control signal POL makes a transition from the second level (e.g., the logic low level) to the first level (e.g., the logic high level), the first output stage OS1 may operate in the first output amplifier OAMP1 and the second output stage OS2 may operate in the second output amplifier OAMP2. After the polarity control signal POL makes the transition from the second level to the first level, as shown in FIG. 18B, the first output switch OSW1 may be turned off and the second output switch OSW2 may be turned on for a predetermined amount of time, so that the third power supply voltage HAVDD may be applied to the source lines S1 and S2 instead of the output voltages of the output amplifiers OAMP1 and OAMP2.

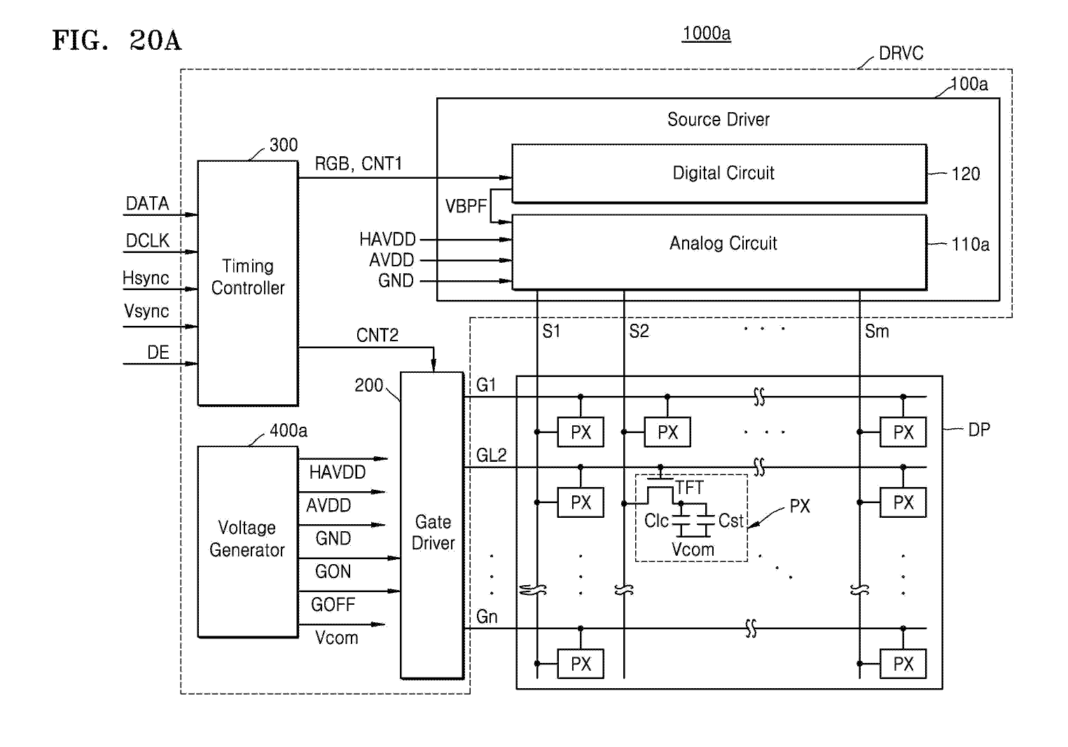

FIG. 19 is a timing diagram of the output buffer unit 133 of FIG. 17.

During a polarity inversion operation, the polarity of pixels may be changed in units of image frames. Accordingly, during an active section (i.e., a section in which an image is displayed on the display panel), the polarity control signal POL may have a fixed value, and a high gradation voltage VGh or a low gradation voltage VG1 output from the output amplifiers OAMP1 and OAMP2 may be output to the source lines S1 and S2. When the vertical blank section begins, the polarity control signal POL may have a level transition. For a predetermined period in the vertical blank section, the first control signal OCS1 may be inactivated, and the second control signal OCS2 may be activated so that the second power supply voltage HAVDD can be applied to the source lines S1 and S2. Subsequently, before an active section of the next image frame begins, the first control signal OCS1 may be activated, and the second control signal OCS2 may be inactivated. Thus, output voltages of the output amplifiers OAMP1 and OAMP2 may be output to the source lines S1 and S2.

The polarity control signal POL may be included in a data packet (refer to SDATA in FIG. 2) and transmitted to the source driver 100a. In this case, the polarity control signal POL may be transmitted along with the vertical synchronous signal FSYNC. Thus, as shown in FIG. 19, when the vertical blank section begins, the polarity control signal POL may make a level transition.

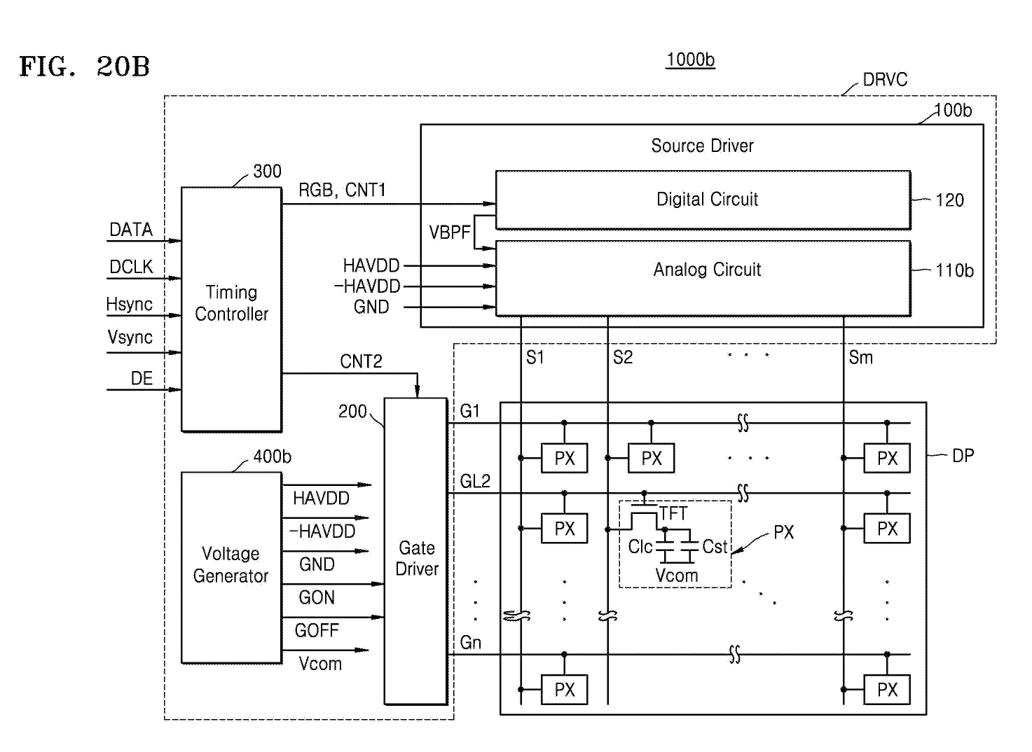

FIGS. 20A and 20B are block diagrams of display devices to which source drivers according to exemplary embodiments of the inventive concept are applied. FIG. 20A illustrates a case in which a source driver 100a operates based on a first power supply voltage AVDD, a second power supply voltage GND, and a third power supply voltage HAVDD. FIG. 20B illustrates a case in which a source driver 100b operates based on the third power supply voltage HAVDD, the second power supply voltage GND, and a fourth power supply voltage −HAVDD. For example, a display device 1000a of FIG. 20A may be a medium or large sized display device mounted on a TV or a monitor. Further, a display device 1000b of FIG. 20B may be a small sized display device mounted on a mobile device, such as a tablet personal computer (PC) or a smartphone.

Referring to FIG. 20A, the display device 1000a may include a display panel DP and a driver circuit DRVC.

The display panel DP may display images in units of frames. The display panel DP may be embodied by a liquid crystal display (LCD), a light-emitting diode (LED) display, an organic LED (OLED) display, an active-matrix OLED (AMOLED) display, or a flexible display or embodied by other kinds of flat panel displays (FPDs). Hereinafter, an example in which the display panel DP is an LCD panel will be described for brevity.

The display panel DP may include a plurality of gate lines GL1 to GLn configured to transmit scan signals in a row direction, a plurality of data lines DL1 to DLm disposed in a direction that intersects the gate lines GL1 to GLn and configured to transmit gradation voltages corresponding to pixel data Data in a column direction, and a plurality of pixels PX arranged in regions where the gate lines GL1 to GLn intersect the data lines D1 to Dm.

The display panel DP may include the gate lines G1 to Gn arranged in the row direction, source lines S1 to Sm arranged in the column direction, and the pixels PX formed at intersections between the gate lines G1 to Gn and the source lines S1 to Sm. In the LCD panel shown in FIG. 20A, each of the pixels PX may include a thin-film transistor (TFT) and an LC capacitor Clc and a storage capacitor Cst connected to a drain electrode of the thin-film transistor TFT. When the gate lines G1 to Gn are sequentially selected, the thin-film transistor TFT of the pixel PX connected to the selected gate line may be turned on, and then a gradation voltage corresponding to pixel data RGB may be applied to each of the source lines S1 to Sn. The gradation voltage may be applied to the LC capacitor Clc and the storage capacitor Cst through the thin-film transistor TFT of the corresponding pixel PX. By driving the LC capacitor Clc and the storage capacitor Cst, a display operation may be enabled.

The driver circuit DRVC may include a source driver 100a, a gate driver 200, a timing controller 300, and a voltage generator 400a. The driver circuit DRVC may be embodied by a single semiconductor chip or a plurality of semiconductor chips.

The timing controller 300 may receive image data DATA, a horizontal synchronous signal Hsync, a vertical synchronous signal Vsync, a clock signal DCLK, and a data enable signal DE from an external apparatus (e.g., a host apparatus (not shown)), and generate control signals CNT1 and CNT2 for controlling the gate driver 200 and the source driver 100a based on the received signals. Also, the timing controller 300 may convert a format of the externally received image data DATA according to specifications for interfacing with the source driver 100a, generate pixel data RGB, and transmit the pixel data RGB to the source driver 100a.

The gate driver 200 and the source driver 100a may drive the pixels PX of the display panel DP in response to the control signals CNT1 and CNT2 generated by the timing controller 300. The source driver 100a may drive the source lines S1 to Sm of the display panel DP based on the source driver control signal CNT1. The source driver 100a may generate a plurality of gradation voltages and output a gradation voltage corresponding to pixel data RGB to the source lines S1 to Sm of the display panel DP. The source driver 100a may be embodied by a single chip or a plurality of chips.

In the exemplary embodiment, the source driver 100a may be the source driver 100 of FIG. 1 or the source driver 100a of FIG. 11. The source driver 100a may include a digital circuit 120 and an analog circuit 110a. The analog circuit 110a may operate in a power-down mode in a non-driving section (e.g., vertical blank section) of the display panel DP, thereby reducing current consumption. Also, the analog circuit 110a may operate with the application of a first power supply voltage AVDD, a second power supply voltage VGND, and a third power supply voltage HAVDD having a voltage level between the first power supply voltage AVDD and the second power supply voltage GND, thereby reducing power consumption.

The gate driver 200 may sequentially scan the gate lines G1 to Gn of the display panel DP. The gate driver 200 may apply a gate-on voltage GON to a selected gate line and activate the selected gate line, and the source driver 100a may output gradation voltages corresponding to pixels PX connected to the activated gate line. Thus, the display panel DP may display images in units of horizontal lines (i.e., by rows).

The voltage generator 400a may generate voltages used by the driver circuit DRVC and the display panel DP. The voltage generator 400a may generate a gate-on voltage GON, a gate-off voltage GOFF, a common voltage VCOM, a first power supply voltage AVDD, a second power supply voltage GND, and a third power supply voltage HAVDD. The gate-on voltage GON and the gate-off voltage GOFF may be provided to the gate driver 200 and used to generate a gate signal to be applied to the gate lines G1 to Gn. The common voltage VCOM may be provided in common to the pixels PX of the display panel DP. As shown in FIG. 20A, the common voltage VCOM may be provided to one end of the LC capacitor Clc and the storage capacitor Cst. The common voltage VCOM may be a ground voltage. The first power supply voltage AVDD, the second power supply voltage GND, and the third power supply voltage HAVDD may be provided to the analog circuit 110 of the source driver 100a. The second power supply voltage GND may be a voltage having the same voltage level as the ground voltage or the common voltage VCOM.

Referring to FIG. 20B, a voltage generator 400b may generate a gate-on voltage GON, a gate-off voltage GOFF, a common voltage VCOM, a second power supply voltage GND, a third power supply voltage HAVDD, and a fourth power supply voltage −HAVDD. The source driver 100b may operate based on a second power supply voltage GND, a third power supply voltage HAVDD, and a fourth power supply voltage −HAVDD. The second power supply voltage GND may be a ground voltage, and the fourth power supply voltage −HAVDD may be a negative voltage. Also, the fourth power supply voltage −HAVDD may be a negative voltage having the same magnitude as the third power supply voltage HAVDD.

The source driver 100b may be the source driver 100 of FIG. 1 or the source driver 100a of FIG. 11. The source driver 100b may include a digital circuit 120 and an analog circuit 110b. The analog circuit 110b may operate in a power-down mode in a non-driving section (e.g., vertical blank section) of a display panel DP, thereby reducing current consumption. Also, the analog circuit 110b may operate with the application of the third power supply voltage HAVDD, the fourth power supply voltage −HAVDD, and the second power supply voltage GND having a voltage level between the third power supply voltage HAVDD and the fourth power supply voltage −HAVDD, thereby reducing power consumption. Since the remaining components and operations of the display device 1000b are similar to those of the display device 1000a of FIG. 20A, repeated descriptions thereof are omitted here.

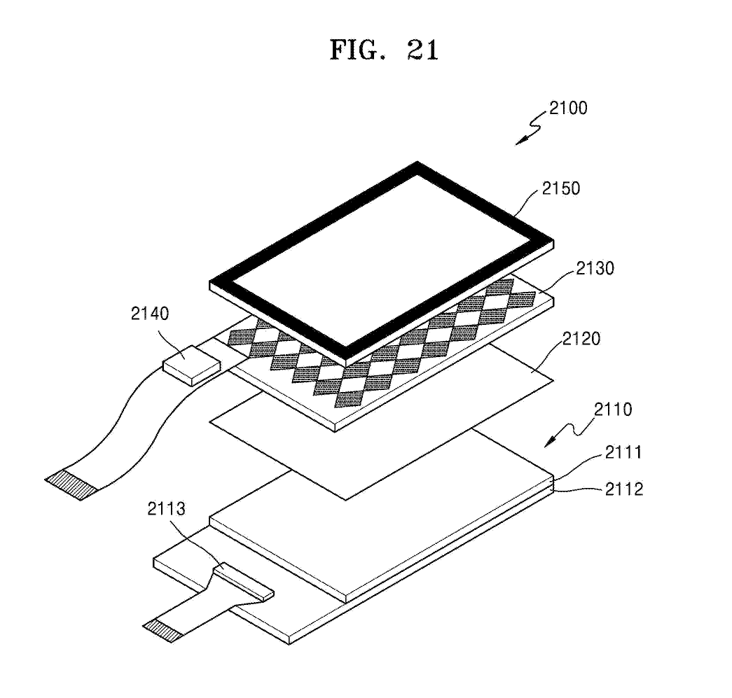

FIG. 21 is a diagram of a display module 2100 according to exemplary embodiments of the inventive concept.

Referring to FIG. 21, the display module 2100 may include a display device 2110, a polarizer 2120, and a window glass 2150. The display device 2110 may include a display panel 2111, a printed substrate 2112, and a display driver integrated circuit (IC) 2113.

The window glass 2150 may be typically formed of acryl or reinforced glass and protect the display module 2100 from external impact or scratches due to repetitive touches. The polarizer 2120 may be provided to improve optical characteristics of the display panel 2111. The display panel 2111 may be formed by patterning a transparent electrode on the printed substrate 2112. The display panel 2111 may include a plurality of pixel cells for displaying a frame. In an exemplary embodiment, the display panel 2111 may be an LC panel, but is not limited thereto. The display panel 2111 may include various kinds of display devices. For example, the display panel 2111 may be one of an OLED display, an electrochromic display (ECD), a digital mirror device (DMD), an actuated mirror device (AMD), a grating light value (GLV), a plasma display panel (PDP), an electro-luminescent display (ELD), an LED display, and a vacuum fluorescent display (VFD).

The display driver IC 2113 may include the source driver 100 of FIG. 1 or the source driver 100a of FIG. 12. Although an example in which the display driver IC 2113 includes a single chip is illustrated in the exemplary embodiment for brevity, the display device IC 2113 may include a plurality of chips. Also, the display driver IC 2113 may be mounted as a chip-on-glass (COG) type on the printed substrate 2112 formed of a glass material, but the inventive concept is not limited thereto. In other embodiments, the display driver IC 2113 may be mounted as various other types, such as a chip-on-film (COF) type or a chip-on-board (COB) type.

The display module 2100 may further include a touch panel 2130 and a touch controller 2140. The touch panel 2130 may be formed by patterning a transparent electrode, such as indium tin oxide (ITO), on a glass substrate or a polyethylene terephthalate (PET) film. The touch controller 2140 may detect the occurrence of touches on the touch panel 2130, calculate touch coordinates, and transmit the touch coordinates to a host (not shown). The touch controller 2140 may be integrated with the display driver IC 2113 in a single semiconductor chip.

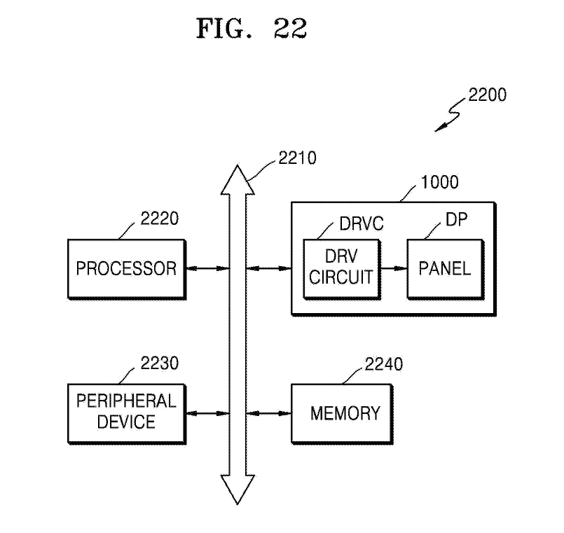

FIG. 22 is a diagram of a display system 2200 according to exemplary embodiments of the inventive concept.

Referring to FIG. 22, the display system 2200 may include a processor 2220, a display device 1000, a peripheral device 2230, and a memory 2240, which may be electrically connected to a system bus 2210.

The processor 2220 may control data to be input to or output from the peripheral device 2230, the memory 2240, and the display device 1000, and perform an image processing operation on image data transmitted between the devices. The display device 1000 may include a display panel DP and a display driver IC DRVC. Image data applied through the system bus 2210 may be stored in a frame memory or line memory included in the display driver IC DRVC, and then displayed on the display panel DP. The display device 1000 may be the display device 1000a of FIG. 20A or the display device 1000b of FIG. 20B.

The peripheral device 2230 may be a device configured to convert moving images or still images captured by a camera, a scanner, or a webcam into electric signals. Image data obtained from the peripheral device 2230 may be stored in the memory 2240 or displayed in real time on the display panel DP of the display device 1000. The memory 2240 may include a volatile memory device, such as dynamic random access memory (DRAM), and/or a non-volatile memory device, such as a flash memory. The memory 2240 may include DRAM, phase-change RAM (PRAM), magnetic RAM (MRAM), resistive RAM (ReRAM), ferroelectric RAM (FRAM), a NOR flash memory, a NAND flash memory, or a fusion flash memory (e.g., a memory in which static RAM (SRAM) buffer, a NAND flash memory, and a NOR interface logic are combined). The memory 2240 may store image data obtained from the peripheral device 2230 or an image signal processed by the processor 2220.

The display system 2200 according to the exemplary embodiment of the inventive concept may be included in a mobile electronic product, such as a tablet PC. However, the inventive concept is not limited thereto, and the display system 2200 may be included in various kinds of electronic products configured to display images.

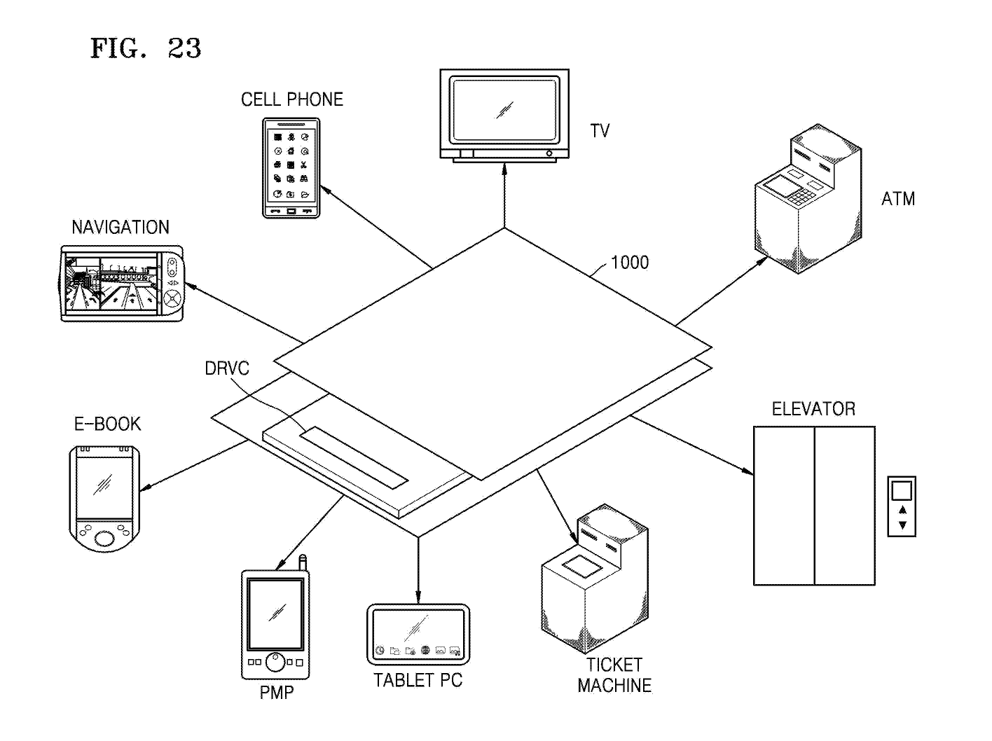

FIG. 23 is a diagram of various application examples of an electronic product on which a display device 1000 according to exemplary embodiments of the inventive concept is mounted. The display device 1000 may be broadly applied not only to a cell phone but also to a TV, an automated teller machine (ATM) configured to perform bank deposits or withdrawals, an elevator, a ticket dispensing machine used at subway stations, a portable media player (PMP), an electronic book (e-book), a navigation system, a tablet PC, etc.

While the inventive concept has been particularly shown and described with reference to exemplary embodiments thereof, it will be understood that various changes in form and details may be made therein without departing from the spirit and scope of the following claims.

What is claimed is:

1. A source driver configured to drive a source line of a display panel, the source driver comprising:
a digital circuit configured to receive and store digital pixel data; and
an analog circuit configured to convert the stored digital pixel data into a gradation voltage and output the gradation voltage,
wherein a static current of the analog circuit is reduced in response to a value of a timing signal corresponding to a non-driving section of the display panel.

2. The source driver of claim 1, wherein the analog circuit comprises at least one amplifier configured to buffer an analog signal, and
wherein an operation of an output buffer comprised in the at least one amplifier is cut off in response to the value of the timing signal corresponding to the non-driving section.

3. The source driver of claim 2, wherein a bias current of the at least one amplifier is reduced or cut off in response to the value of the timing signal corresponding to the non-driving section.

4. The source driver of claim 1, wherein the analog circuit comprises:
a gamma block configured to generate a plurality of gradation voltages; and
an output buffer configured to buffer and output a selected gradation voltage which corresponds to the pixel data, among the gradation voltages.

5. The source driver of claim 4, wherein the output buffer comprises:
a plurality of output amplifiers, each output amplifier of the output amplifiers comprises an input stage and an output stage; and
a bias circuit configured to generate a bias signal which controls a plurality of biases of the plurality of output amplifiers,
wherein the bias circuit reduces or cuts off a bias current of each of the output amplifiers in response to the value of the timing signal corresponding to the non-driving section of the display panel and cuts off an operation of the output stage of at least one output amplifier in response to the value of the timing signal corresponding to the non-driving section of the display panel.

6. The source driver of claim 4, wherein the gamma block comprises:
a plurality of gamma amplifiers configured to buffer a plurality of received gamma reference voltages;
a bias circuit configured to generate a bias signal which controls a plurality of biases of the plurality of gamma amplifiers; and
a voltage divider configured to voltage divide the buffered gamma reference voltages,
wherein operations of an output stage of at least one gamma amplifier of the plurality of gamma amplifiers are blocked in response to the value of the timing signal corresponding to the non-driving section.

7. The source driver of claim 6, wherein in response to the value of the timing signal corresponding to the non-driving section, one of the gamma reference voltages and power supply voltages is applied to one terminal of the voltage divider.

8. The source driver of claim 6, wherein in response to the value of the timing signal corresponding to the non-driving section, at least one gamma amplifier of the plurality of gamma amplifiers operates, and one terminal of the voltage divider is connected to an output of the at least one gamma amplifier.

9. The source driver of claim 4, wherein the output buffer comprises a plurality of output amplifiers, each output amplifier of the output amplifiers comprises an input stage configured to operate with an application of a first power supply voltage and a second power supply voltage, a first output stage configured to operate with an application of the first power supply voltage and a third power supply voltage, and a second output stage configured to operate with an application of the third power supply voltage and the second power supply voltage, and
wherein one output stage of the first output stage and the second output stage of each of the plurality of output amplifiers selectively operates based on a polarity control signal.

10. The source driver of claim 9, further comprising:
a switch configured to transmit the third power supply voltage to the source line of the display panel in a polarity inversion section instead of transmitting an output voltage of the output amplifier to the source line of the display panel.

11. A source driver comprising:
a gamma block which comprises a plurality of gamma amplifiers and is configured to generate a plurality of gradation voltages; and
an output buffer configured to buffer and output a gradation voltage which corresponds to pixel data, among the plurality of gradation voltages,
wherein an input stage and an output stage of at least one gamma amplifier of the plurality of gamma amplifiers have different operating voltage ranges,
wherein the input stage of the at least one gamma amplifier has a wider operating voltage range than the output stage of the at least one gamma amplifier.

12. The source driver of claim 11, wherein some of the plurality of gamma amplifiers generate output voltages based on a first power supply voltage and a third power supply voltage, and some others of the plurality of gamma amplifiers generate output voltages based on a second power supply voltage and the third power supply voltage.

13. The source driver of claim 12, wherein a sink current of the some of the gamma amplifiers is reused as a source current of the some others of the gamma amplifiers.

14. The source driver of claim 12, wherein the some of the gamma amplifiers have symmetric configurations with respect to the some others of the gamma amplifiers.

15. The source driver of claim 12, wherein the third power supply voltage is a middle voltage which is between the first power supply voltage and the second power supply voltage.

16. A source driver comprising:
a digital circuit which is configured to receive pixel data and a control signal and output the pixel data; and
an analog circuit which is configured to receive the output pixel data and a vertical blank signal and output a gradation voltage,
wherein a static current of the analog circuit is reduced in response to a predefined value of the vertical blank signal.

17. The source driver of claim 16, wherein the predefined value of the vertical blank signal corresponds to a non-driving section of a display panel.

18. The source driver of claim 17, wherein the non-driving section of the display panel is a vertical blanking section in which the gradation voltage is not applied to pixels of the display panel.

19. The source driver of claim 16, wherein the digital circuit further comprises:
a control logic which is configured to generate a vertical synchronous start signal, a load signal, and the vertical blank signal based on the control signal;
a shift register which is configured to sequentially shift the vertical synchronous start signal and output shifted clock signals; and
a data latch which is configured to output the pixel data in response to the load signal.

20. The source driver of claim 16, wherein the analog circuit further comprises:
a gamma block which is configured to generate a plurality of gradation voltages which correspond to respective gray levels of the pixel data in response to the vertical blanking signal;
a digital to analog converter which is configured to receive the pixel data and output an analog gradation voltage which corresponds to the pixel data of the gradation voltages; and
an output buffer configured to buffer and output the analog gradation voltage.
